(19) United States
(12) Patent Application Publication
(10) Pub. No.: US 2002/0052751 A1
(43) Pub. Date: May 2, 2002

(54) System and method for providing a transporation service

(75) Inventor: Shinji Ebata, Tokyo (JP)

Correspondence Address: SUGHRUE, MION, ZINN, MACPEAK & SEAS, 2100 Pennsylvania Avenue, N.W., Washington, DC, 20037, US

(73) Assignee: NEC CORPORATION

(21) Appl. No.: 09/851,248

(22) Filed: May 9, 2001

(30) Foreign Application Priority Data
May 19, 2000 (JP) 152780/2000

(51) Int. Cl. G06F 17/60

(52) U.S. Cl. 705/1; 705/400; 705/7

(57) ABSTRACT

Each taxi detects, by a GPS terminal mounted thereon, its present location using information sent from a GPS satellite and sends to a center equipment the present location and information on a destination specified by a customer. The center equipment finds an optimal route, a charge for the route, and the like, according to the information on the present location and the destination, received via the Internet. The equipment then transmits the optimal route, charge, and the like to the taxi. The center equipment which controls taxis in a centralized manner has a function to calculate an optimal route from the present location to the destination. This minimizes the cost for a taxi company and simplifies administration of taxis.

### BACKGROUND OF THE INVENTION

The present invention relates to a transportation service system and a method of providing a transportation service, which has a function to select an optimal route and to calculate a charge for the route associated with the transportation service provided by a taxi. Particularly, the present invention relates to a system and method for providing a transportation service, in which the function is disposed of on a center equipment that administers taxis in a centralized fashion.

### DESCRIPTION OF THE PRIOR ART

Global Positioning System (GPS) for determining a present position or location of a moving object is well known as a system that has a remarkable high-positioning precision compared with ordinary long range aid to navigation (LORAN) and OMEGA. The GPS employs orbiting satellites (hereinafter referred to as GPS satellites) at predetermined points, therefore it can be used anywhere on the earth irrespective of locations on the land or at sea. Since the GPS satellites are arranged in a three-dimensional space centered on the earth, location of a moving object can be determined with three-dimensional coordinates thereof by receiving radio waves transmitted from four GPS satellites. The waves are hereinafter referred to as GPS radio waves.

The GPS satellites transmit signals having the same frequency, however different pseudo noise (PN) sequences are assigned to each of GPS satellites. Signals transmitted from each GPS satellite include its time and its own position. GPS terminal determines its own position according to a time difference between time information transmitted from the GPS satellite and a time local to the GPS terminal, and to satellite position information.

The GPS was originally designed with a positioning error of about 100 meters. However, it has been realized through the actual operation that the GPS is capable of functioning with an error smaller than the originally designed value. This is problematic in a strategic issue, therefore an intentional error was once added to a measured result. Specifically, the GPS was controlled not to provide an accuracy of about 100 meters.

However, the U.S. government has recently announced to increase the GPS accuracy to about ten times higher that of the existing GPS. For each equipment manufacture, this eliminates a processing by software for correcting positions and distances to improve accuracy. Accordingly, it is expected that the announcement spurs decrease in price of GPS terminals and the terminals will become more widely used.

The GPS has been introduced to various fields for civilian and private use. Particularly, a car navigation system for determining position of a car using the GPS has been increasingly and widely spread these years. The car navigation system requires each car to equip a GPS terminal so that the terminal displays on a screen a present location of the car by referring to map information stored, for example, in a compact disk (CD) read-only memory (ROM) which is called a map matching technique.

A technique of positioning cars using the car navigation system has been conventionally employed in a transportation industry, say a taxi company. Japanese Patent Laid-Open Publication No. 10-141972 describes one of applications using the positioning technique.

In the prior art technique, a GPS terminal installed in a taxi finds an optimal route, according to information on a present location of the taxi and information on destination inputted from an input device of the GPS terminal. In addition, according to the optimal route and traffic information stored in a storage device, the GPS terminal calculates a charge for a route from the present location to the destination, and an expected arrival time, then the terminal displays the charge and arrival time on a screen.

However, the conventional GPS terminal is expensive because of the built-in software for finding an optimal route from the present location to the destination, and for calculating a charge for the optimal route and the expected arrival time. Accordingly, if each taxi has such GPS terminal in it, there is a problem that it cost a great deal for a taxi company.

### SUMMARY OF THE INVENTION

In view of the above-mentioned problem, it is an object of the present invention to provide a transportation service system and a method thereof in which the function to find an optimal route from the present location to the destination is disposed of on a center side which administers taxis in a centralized fashion, so that a taxi company can reduce the cost, and a business administration regarding taxis is simplified.

Furthermore, another object of the present invention is to provide a transportation service system and a method thereof in which a charge for the service and the like can be presented to a customer before starting a transportation service which is provided to a customer. The customer can therefore ask for the transportation service at ease. If the taxi company receives from the customer the charge presented as a charge for that service before the transportation service is provided, it is possible for the company to avoid a troublesome business such as free ride.

Still another object of the present invention is to provide a transportation service system and a method thereof in which the center side finds a plurality of appropriate routes between the present location and the destination in accordance with different criteria, and the customer can select an optimal route suitable for her or his requirement.

Another object of the present invention is to provide a transportation service system and a method thereof in which, even in a case where the customer changes the destination while the service is being provided, the center side finds an optimal route and calculates a charge for the new destination. Therefore, the present invention system and method arises no problems related to a new charge and to operation of the service provided by the taxi company.

To achieve the objects according to the present invention, there is provided a transportation service system, comprising: at least one Global Positioning System (GPS) satellite for transmitting information used to detect a position of a moving object; at least one taxi having a GPS terminal which receives said information from said GPS satellite and detects a present location of said taxi on the basis of said information, for transmitting present-location information regarding said detected present location and destination information indicating a destination specified by a customer; and a center equipment for receiving said present-location information and destination information, for finding an optimal route to obtain optimal-route information in accordance with said present-location information and destination information, and for transmitting information including said optimal-route information to said taxi.

The center equipment comprises a server for communicating information with said taxi and executing a predetermined processing; and Intelligent Transportation System (ITS) information receiving means connected to said server, for receiving ITS information offered by said ITS, said server comprising; first communication control means for communicating information with each of said at least one taxi; first map-information storage means for storing map information for each area; preset-charge storage means for storing service-charge information associated with a taxi company; and first control means connected to each of said first communication control means, said first map-information storage means, and said preset-charge storage means, for controlling each of said means, wherein said first control means reads from said first map-information storage means map information corresponding to said destination information and said present-location information received by said first communication control means, obtains said ITS information from said ITS information receiving means, reads said service-charge information from said preset-charge storage means, and calculates in accordance with said map information, with said ITS information, and with said service-charge information, said optimal route, a distance from said present location to said destination associated with said optimal route, a required driving time associated with said optimal route, and a charge for said optimal route.

Furthermore, if the customer changes the destination to a new destination when a service is being provided by said taxi, said taxi transmits to said center equipment present-location information at the time of said change as new present-location information, and destination information indicating said new destination, in said center equipment; said first communication control means receives said new present-location information and new destination information, and said first control means obtains new ITS information from said ITS information receiving means, reads from said first map-information storage means new map information corresponding to said new present-location information and said new destination information, and finds according to said new ITS information, to said new map information, and to said new service-charge information, a new optimal route, a distance from said new present location to said new destination designated by said new optimal route, a required driving time required by said taxi associated with said new optimal route, and a charge for said new optimal route.

The taxi has said GPS terminal and second communication control means connected to said GPS terminal, for communicating information with said center equipment, said GPS terminal comprising; input means for inputting a destination specified by the customer, second map-information storage means for storing map information for each area, image display means for displaying an image, and second control means connected to said input means, second map-information storage means, and image display means, for controlling each of said means, said second control means detecting said present-location information from radio waves received from said GPS satellite, and sending to said first communication control means said present-location information and destination information indicative of said destination inputted from said input means, said second communication control means sending to said center equipment said present-location information and said destination information received from said second control means, and sending to said second control means information received from said center equipment, and said second control means reading from said second map-information storage means map information corresponding to said optimal route included in information received from said second communication control means, displaying on said image display means said optimal route by superposing the route on said map information, and displaying a distance from said present location to said destination associated with said optimal route included in said information transmitted from said center equipment, a required driving time associated with said optimal route, and a charge for said optimal route.

The present invention also provides a transportation service system, comprising: at least one global positioning system (GPS) satellite for transmitting information used to detect a position of a moving object; at least one taxi having a GPS terminal which receives said information from said GPS satellite and detects a present location of said taxi on the basis of said information, for transmitting present-location information regarding said detected present location and destination information indicating a destination specified by a customer; and a center equipment for receiving said present-location information and destination information, for finding respective optimal routes for each of plural different items to obtain optimal-route information in accordance with said present-location information and destination information, and for transmitting information including said optimal-route information to said taxi.

The center equipment comprises: a server for communicating information with said taxi and executing a predetermined processing; and Intelligent Transportation System (ITS) information receiving means connected to said server, for receiving ITS information offered by said ITS; said server having: first communication control means for communicating information with each of said at least one taxi; first map-information storage means for storing map information for each area; preset-charge storage means for storing service-charge information associated with a taxi company; and first control means connected to each of said first communication control means, first map-information storage means, and preset-charge storage means, for controlling each of said first communication control means, first map-information storage means, and preset-charge storage means, wherein said first control means reads from said first map-information storage means map information corresponding to said destination information and said present-location information received by said first communication control means, obtains said ITS information from said ITS information receiving means, reads said service-charge information from said preset-charge storage means, and calculates for each of said plural different items, in accordance with said map information, with said ITS information, and with said service-charge information, said respective optimal routes, a distance from said present location to said destination associated with said respective optimal routes, a required driving time associated with said respective optimal routes, and charges for said respective optimal routes.

Furthermore, if the customer changes the destination to a new destination when a service is being provided by said taxi, said taxi transmits to said center equipment present-location information at the time of said change as new present-location information, and destination information indicating said new destination, in said center equipment; said first communication control means receives said new present-location information and new destination information, and said first control means obtains new ITS information from said ITS information receiving means, reads from said first map-information storage means new map information corresponding to said new present-location information and said new destination information, and finds for each of said plural different items, according to said new ITS information, to said new map information, and to said new service-charge information, new respective optimal routes, a distance from said new present location to said new destination designated by said new respective optimal routes, a required driving time required by said taxi associated with said new respective optimal routes, and charges for said new respective optimal routes.

The taxi has said GPS terminal and second communication control means connected to said GPS terminal, for communicating information with said center equipment, said GPS terminal comprising; input means for inputting a destination specified by the customer, second map-information storage means for storing map information for each area, image display means for displaying an image, and second control means connected to said input means, second map-information storage means, and image display means, for controlling each of said means, said second control means detecting said present-location information from radio waves received from said GPS satellite, and sending to said first communication control means said present-location information and destination information indicative of said destination inputted from said input means, said second communication control means sending to said center equipment said present-location information and said destination information received from said second control means, and sending to said second control means information received from said center equipment, and said second control means reading from said second map-information storage means map information corresponding to said respective optimal routes for each of said plural different items included in information received from said second communication control means, displaying on said image display means said respective optimal routes by superposing the route on said map information, and displaying a distance from said present location to said destination associated with said respective optimal routes included in said information transmitted from said center equipment, a required driving time associated with said respective optimal routes, and charges for said respective optimal routes.

In accordance with the present invention, there is provided a method of providing a transportation service in a system which comprises at least one Global Positioning System (GPS) satellite, a GPS terminal, a center equipment, and at least one taxi on which said GPS terminal is mounted, said method comprising the steps of detecting by said GPS terminal its present location according to information for finding a position of a moving object transmitted from said GPS satellite; transmitting from said taxi present-location information on said present location, and destination information indicating a destination specified by a customer; and receiving by said center equipment said present-location information and said destination information, obtaining optimal-route information on an optimal route according to said present-location information and destination information, and transmitting information including said optimal-route information to said taxi.

The present invention also provides a method of providing a transportation service in a system which comprises at least one Global Positioning System (GPS) satellite, a GPS terminal, a center equipment, and at least one taxi on which said GPS terminal is mounted, said method comprising the steps of detecting by said GPS terminal its present location according to information for finding a position of a moving object transmitted from said GPS satellite; transmitting from said taxi present-location information on said present location, and destination information indicating a destination specified by a customer; and receiving by said center equipment said present-location information and said destination information, finding as information respective optimal routes for each of plural different items according to said present-location information and destination information, and transmitting information including said optimal-route information to said taxi.

Furthermore, the present invention provides a method of providing a transportation service in a system which comprises at least one Global Positioning System (GPS) satellite, a GPS terminal, a portable telephone terminal, a center equipment, and at least one taxi on which said GPS terminal and portable telephone terminal are mounted, said center equipment having a communication controller, a controller, a map-information storage unit, a preset-charge information storage unit, and an ITS information receiver, said method comprising the steps of detecting by said GPS terminal its present location according to information for finding a position of a moving object transmitted from said GPS satellite; transmitting from said portable telephone terminal present-location information on said present location and destination information indicating a destination specified by a customer of said taxi; receiving by said communication controller said present-location information and destination information, and reading from said map-information storage unit, under the control of said controller, map information corresponding to said present-location information and destination information; finding by said controller according to said read map information, a plurality of routes connecting said present location and destination; receiving by said ITS information receiver ITS information provided by the ITS, and acquiring said ITS information by said controller; calculating by said controller according to said acquired ITS information a required driving time for each of said plural routes; determining by said controller an optimal route from said plural routes, which is a shortest-time route having a shortest required driving time; calculating by said controller according to said map information a distance between said present location and destination associated with said shortest-time route; reading from said preset-charge information storage unit under the control of said controller, service-charge information associated with a taxi company; calculating by said controller according to said read service-charge information, a charge for said shortest-time route; and generating by said controller information including shortest-time route information indicative of said shortest-time route, distance information indicative of said distance, and charge information indicative of said charge, and transmitting said information from said communication controller to said taxi by adding address information of said portable telephone terminal to said generated information.

In accordance with the present invention, there is provided a method of providing a transportation service in a system which comprises at least one Global Positioning System (GPS) satellite, a GPS terminal, a portable telephone terminal, a center equipment, and at least one taxi on which said GPS terminal and portable telephone terminal are mounted, said center equipment having a communication controller, a controller, a map-information storage unit, a preset-charge information storage unit, and an ITS information receiver, said method comprising the steps of detecting by said GPS terminal its present location according to information for finding a position of a moving object transmitted from said GPS satellite; transmitting from said portable telephone terminal present-location information on said present location and destination information indicating a destination specified by a customer of said taxi; receiving by said communication controller said present-location information and destination information, and reading from said map-information storage unit, under the control of said controller, map information corresponding to said present-location information and destination information; finding by said controller according to said read map information, a plurality of routes connecting said present location and destination; calculating by said controller according to said map information, a distance from said present location to said destination for each of said plural routes; determining by said controller one of optimal routes which is a shortest route having the shortest distance among said plural routes; receiving by said ITS information receiver ITS information provided by the ITS, and acquiring said ITS information by said controller; calculating by said controller according to said acquired ITS information, a required driving time for each of said plural routes; determining by said controller one of optimal routes which is a shortest-time route having a shortest required driving time among said plural routes; reading from said preset-charge information storage unit under the control of said controller, service-charge information associated with a taxi company; calculating by said controller according to said service-charge information, a charge for each of said plural routes; determining by said controller one of optimal routes which is a lowest-charge route having a lowest charge among said plural routes; and generating by said controller information including information indicating said shortest-distance route and its distance, information indicating said shortest-time route and its time, and information indicating said lowest-charge route and its charge, and transmitting said information to said taxi by adding address information of said portable telephone terminal to said generated information.

Furthermore, the present invention provides a method of providing a transportation service, comprising the steps of: presenting to a customer by a taxi driver a charge for a transportation service corresponding to a destination specified by the customer when the customer gets in the taxi; and paying for said charge by the customer before said transportation service is provided by the taxi.

The present invention also provides a method of providing a transportation service, comprising the steps of: finding respective optimal routes between a destination specified by a customer when the customer gets in the taxi and a present location at the time of said change, for respective different items; calculating for said respective optimal routes charges for said transportation service provided by the taxi; presenting to a customer by a taxi driver each of said charges calculated respectively for said optimal routes; and selecting by the customer one of said optimal routes, and paying by the customer for a charge for said selected optimal route, before said transportation service is provided by the taxi.

### BRIEF DESCRIPTION OF THE DRAWINGS

The objects and features of the present invention will become more apparent from the consideration of the following detailed description taken in conjunction with the accompanying drawings in which:

FIG. 1 is a schematic diagram showing a transportation service system according to a first embodiment of the present invention;

FIG. 2 is a functional block diagram of a taxi as a constituent element of a transportation service system according to a first embodiment of the present invention;

FIG. 3 is a functional block diagram showing a center equipment as a constituent element of a transportation service system according to a first embodiment of the present invention;

FIG. 4 is a first sequence diagram illustrating by way of example the operation of a transportation service system according to a first embodiment;

FIG. 5 is a second sequence diagram showing by way of example the operation of a transportation service system according to a second embodiment of the present invention;

FIG. 6 is a third sequence diagram showing the operation of a transportation service system according to a third embodiment of the present invention;

FIG. 7 is a fourth sequence diagram showing the operation of a transportation service system according to a fourth embodiment of the present invention;

FIG. 8 is a first flowchart showing a calculation operation of an optimal route and the like by a controller of a center equipment according to a first embodiment of the present invention;

FIG. 9 is a second flowchart showing a calculation operation of an optimal route and the like by a controller of a center equipment according to a second embodiment of the present invention;

FIG. 10 is a third flowchart showing a calculation operation of an optimal route and the like by a controller of a center equipment according to a third embodiment of the present invention;

FIG. 11 is a fourth flowchart showing an example of operation to calculate an optimal route and the like by a controller of a center equipment according to a fourth embodiment of the present invention;

FIG. 12 is a fifth flowchart showing by way of example the operation to calculate a charge by a controller of a center equipment according to a third embodiment of the present invention;

FIG. 13 is a diagram for describing a charge calculation operation by a controller of a center equipment when a customer changes a destination;

FIG. 14 is a table related to administration method of business results executed by a center equipment according to the present invention;

FIG. 15 is a diagram for showing an example of service-charge information stored in a preset charge information storage section of a center equipment according to the present invention;

FIG. 16A is a diagram explaining an optimal route calculated by a system according to the present invention; and

FIG. 16B is a diagram explaining an optimal route calculated by a system according to the present invention.

### DESCRIPTION OF THE EMBODIMENTS

To clarify functions and operations of the present invention, description will now be given of operation and constitution of a transportation service system according to the present invention.

A transportation service system according to the present invention includes at least one GPS satellite for transmitting information such as information related to time and information on a GPS satellite's position used for detecting location of a moving object (a taxi in this example), at least one taxi which is equipped with a GPS terminal for receiving information from the GPS satellite to detect a present location, and a center equipment for deriving an optimal route and calculating a charge for the optimal route depending upon information on the present location detected by the GPS terminal and destination information to be transmitted together with the present-location information. The center equipment transmits the optimal route and charge to the taxi.

Each taxi finds its own location by using the GPS terminal which detects the location according to information sent from the GPS satellite. Present-location information so obtained is transmitted from the taxi to the center equipment, together with information on the destination specified by a customer (passenger in this case). Though any known prior-art communication technique can be used to transmit the information from the taxi to the center equipment, it is possible to use, for example, a portable telephone terminal which transmits the information to the center equipment via a portable telephone communication network and the Internet.

The center equipment finds an optimal route and calculates a charge for the optimal route, and the like, according to the present-location information and destination information received via the Internet, which are sent to the taxi. For finding an optimal route, the center equipment can access information supplied from Intelligent Transportation System (ITS).

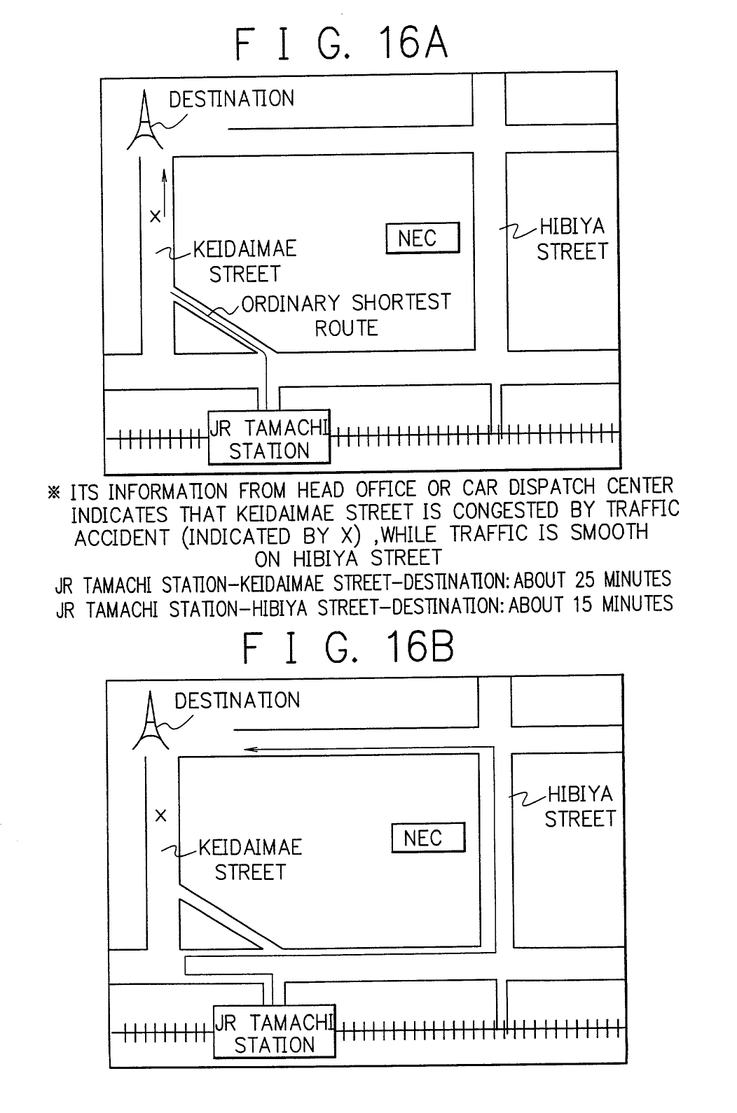

Using the ITS, the center equipment can find, for example, a detour as an optimal route by which the taxi can arrive at the destination in a shorter period of time than the original optimal route which provides the shortest route to the destination as shown in FIGS. 16A and 16B, when the original route is congested. Any known prior-art communication technique can be used for transmitting the information found in the center equipment to the taxi. For example, the information can be sent to a portable telephone terminal equipped in the taxi, via a portable telephone communication network and the Internet.

When the information on the optimal route and the charge is received by the portable telephone terminal in the taxi, the information is transmitted to the GPS terminal which displays it on its screen. A taxi driver can therefore present to a passenger a scheduled route and a charge therefor by visually checking the information items displayed on the screen and by showing a passenger the displayed items.

According to the present invention, information on a route and information on a charge thus found and calculated are managed by the center equipment in each case for each taxi. The present invention therefore makes it possible to simplify management for business results of each taxi.

According to the present invention, in a case where a passenger changes the destination to a new one while a transportation service is being provided, a taxi transmits information on a present location at the time of said change and information on the new destination to the center equipment. The center equipment finds a new optimal route and calculates a charge for the new route, according to the received information, and then sends to the taxi information regarding the new optimal route and the charge for the route. Upon reception of the information by a portable telephone terminal equipped in the taxi, the received information is sent to a GPS terminal to be displayed on a screen.

Accordingly, even when a passenger changes the destination while the transportation service is being provided, the center equipment can find a new optimal route and calculate a charge for the route corresponding to the destination change. The new optimal route can therefore be shown to the taxi driver and passenger. The center equipment updates optimal routes and a charge for these routes, thus capable of managing business results appropriately for each taxi.

According to the present invention, when a passenger changes the destination while the service is provided, the center equipment calculates a charge for the new route and a difference in charge between the new charge and a charge originally calculated. The center equipment transmits to the taxi information regarding the new charge, together with information on difference in charge. In such a case, a passenger can ask for the service at ease even when he or she changes the destination, because he or she is notified of a payable charge in advance.

Additionally, according to the present invention, the center equipment finds plural optimal routes between the present location and the destination based on different criteria, depending upon the present-location information and the destination information sent from each taxi. The center equipment also calculates a charge for each optimal route. The optimal route and charge therefor are sent to the taxi. Upon reception of the information by a portable telephone terminal equipped in the taxi, the information received is sent from the portable telephone terminal to a GPS terminal to be displayed on a screen. It is noted that the information items mentioned above include a period of time required for transportation, a charge therefor, and a related distance.

According to the present invention, a passenger can select his or her required route from among a plurality of routes, which makes the service correspond to the need of the passenger.

Description will now be given of embodiments of the present invention by referring to the accompanying drawings.

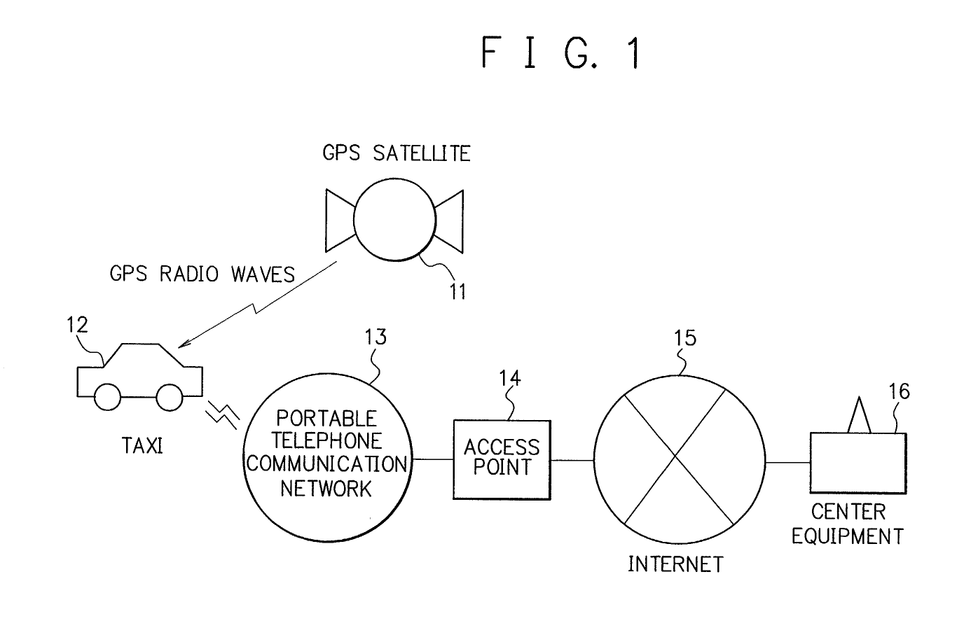

FIG. 1 schematically shows a construction of a transportation service system according to the present invention. The system as shown in FIG. 1 includes at least one GPS satellite 11 which is an intermediate orbiter orbiting the earth in about 12 hours, at least one taxi 12 traveling on the ground, and a center equipment 16 which administers the taxi 12 and communicates necessary information with the taxi 12.

The taxi 12 has a GPS terminal on board (not shown) which receives GPS radio waves transmitted from the GPS satellite 11 and finds its own location according to information such as time information and position information related to the GPS satellite, propagated on the GPS radio waves. The taxi 12 sends information on the present location and the like found by the GPS terminal, that is, information on the present location of the taxi 12, to the center equipment 16.

In the present embodiment, each taxi (the taxi 12 in FIG. 1) uses a portable telephone terminal to send and receive the information. The portable telephone terminal is connected to the GPS terminal. Information such as the present-location information found by the GPS terminal is sent from the portable telephone terminal to the center equipment 16.

As shown in FIG. 1, information transmitted from the portable telephone terminal is sent to an access point 14 including a dedicated server device called a gateway server, via a portable telephone network 13. In the access point 14, the gateway server performs a protocol conversion, a data conversion, and the like. Information from the portable telephone terminal is then transmitted from the access point 14 to the center equipment 16 via the Internet 15.

In addition to the present-location information associated with the taxi 12 (the present-location information of the GPS terminal), information sent from the portable telephone terminal includes information on the destination specified by a passenger. When a passenger takes a seat in the taxi 12 and specifies the destination, a driver inputs the destination using an input device of the GPS terminal. The information on the destination is then sent from the portable telephone terminal.

When the center equipment 16 receives the information via the Internet, it starts finding and calculating according to the present-location information and destination information contained in the received information, an optimal route from the present location of the taxi 12 indicated by the present-location information to the destination indicated by the destination information, a service charge for the route, a distance from the present location to the destination on the route, a required traveling time, and the like.

These information items made by the center equipment 16 are transmitted in the opposite direction compared with the information reception, from the center equipment 16 to the taxi 12 via the Internet 15 and the portable telephone terminal network 13. On receipt of the information by the portable telephone terminal of the taxi 12, the terminal sends the information to the GPS terminal to display the received information items on a display device of the GPS terminal.

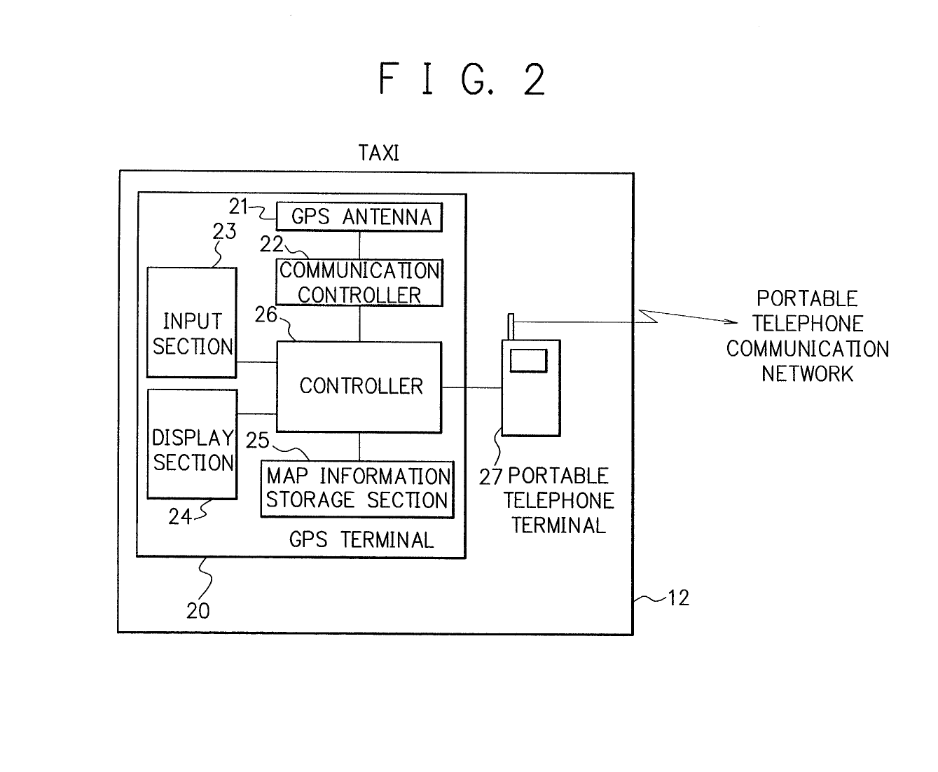

FIG. 2 shows a functional block diagram of the taxi 12 according to the transportation service system of the present invention. In FIG. 2, a GPS terminal 20 loaded on the taxi 12 includes a GPS antenna 21 to receive GPS radio waves sent from the GPS satellite 11, a communication controller 22 to control communications with the GPS satellite 11, an input section 23 for inputting the destination, a map information storage section 25 to store map information for individual areas, a display section 24 to display an image thereupon, and a controller 26 connected to the respective components of the GPS terminal 20 to control overall functions of the terminal. The GPS terminal 20 is externally connected to a portable telephone terminal 27 which is coupled with the controller 26 of the GPS terminal 20.

Description will now be given of operation of the GPS terminal 20 and the portable telephone terminal 27. The GPS terminal 20 receives by the GPS antenna 21 the GPS radio waves transmitted from the GPS satellite 11, under the control of the communication controller 22. Information carried on the GPS radio waves is fed to the controller 26 which accordingly detects the present location of the GPS terminal 20. The present-location information is sent to the portable telephone terminal 27 under the control of the controller 26. As described above, the destination information associated with a passenger which has been inputted from the input section 23 is also transmitted together with the present-location information to the portable telephone terminal 27. The terminal 27 then sends the information received from the GPS terminal 20 to the portable telephone network 13.

The information sent from the center equipment 16 toward the taxi 12 is received by the portable telephone terminal 27, via the Internet 15 and the portable telephone network 13. The information thus received is then delivered to the controller 26 of the GPS terminal 20. The controller 26 reads out map information corresponding to the received information from the map information storage section 25, and superposes an optimal route on the map read from the storage section 25 using the display section 24. The controller 26 also controls to display such information items as a charge, a required traveling time, and a distance associated with the route.

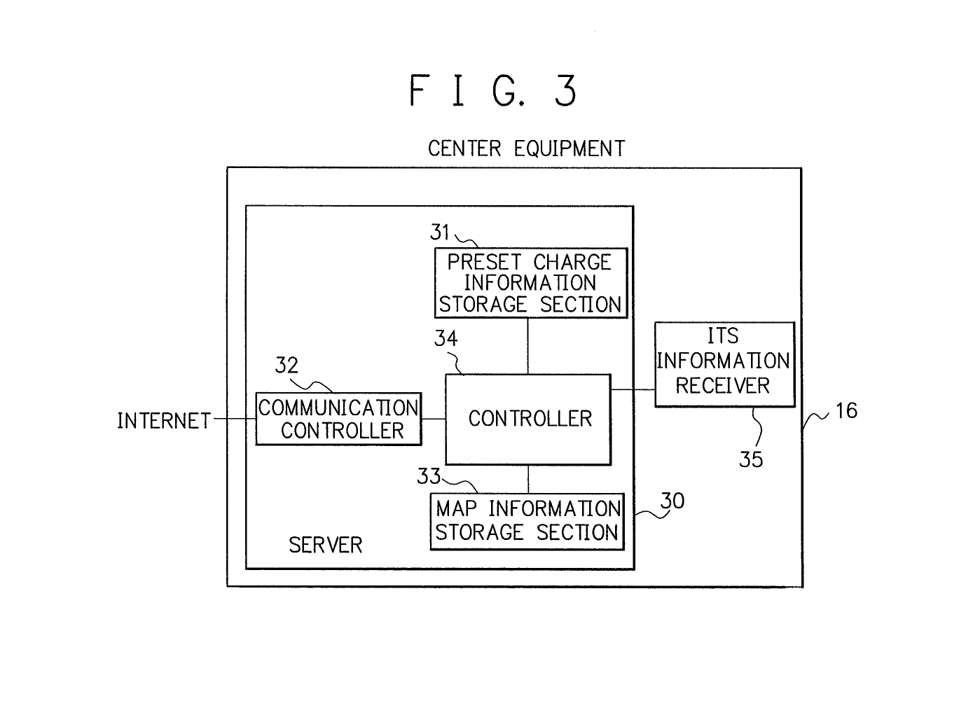

FIG. 3 is a functional block diagram of the center equipment 16 in the transportation service system according to the present invention. In FIG. 3, a server 30 as a constituent component of the center equipment 16 of the present embodiment includes a communication controller 32 to send and receive information via the Internet 15, a map information storage section 33 to store map information for individual areas, a preset charge information storage section 31 to store service-charge information set by the taxi company, and a controller 34 connected to the respective components of the server 30 to control overall functions of the server.

The server 30 is externally connected to an ITS information receiver 35 to receive ITS information. The receiver 35 is coupled to the controller 34 of the server 30 as shown in the diagram.

Description will now be given of operation of the server 30 and the ITS information receiver 35 according to the present embodiment. When the taxi 12 transmits destination information and present-location information via the portable telephone network and the Internet 15, the communication controller 32 of the center equipment 16 receives these pieces of information and delivers the information to the controller 34. The controller 34 then reads out from the map information storage 33 map information corresponding to the received information.

Based on the destination information and present-location information received from the tax 12 and on the map information read out from the map information storage section 33, the controller 34 finds one or a plurality of optimal routes between the present location and the destination. The controller 34 also calculates a distance concerning each route thus found. The ITS information receiver 35 receives traffic information supplied sequentially from the ITS. Each time such traffic information is received, the receiver 35 sends the information to the controller 34.

The controller 34 calculates a required traveling time for each of the optimal routes, according to the latest information among the ITS information received by the ITS receiver 35. The controller 34 reads out from the preset charge information storage section 31 service-charge information associated with the taxi company so as to calculate a charge for each route, according to the service-charge information and to the distance information and required traveling time information calculated for each route.

Under the control of the controller 34, information indicating the optimal route found, a service charge therefor, a distance, and a required traveling time to which address information of the portable telephone terminal 27 is added, is sent from the communication controller 32 to the taxi 12 via the Internet 15.

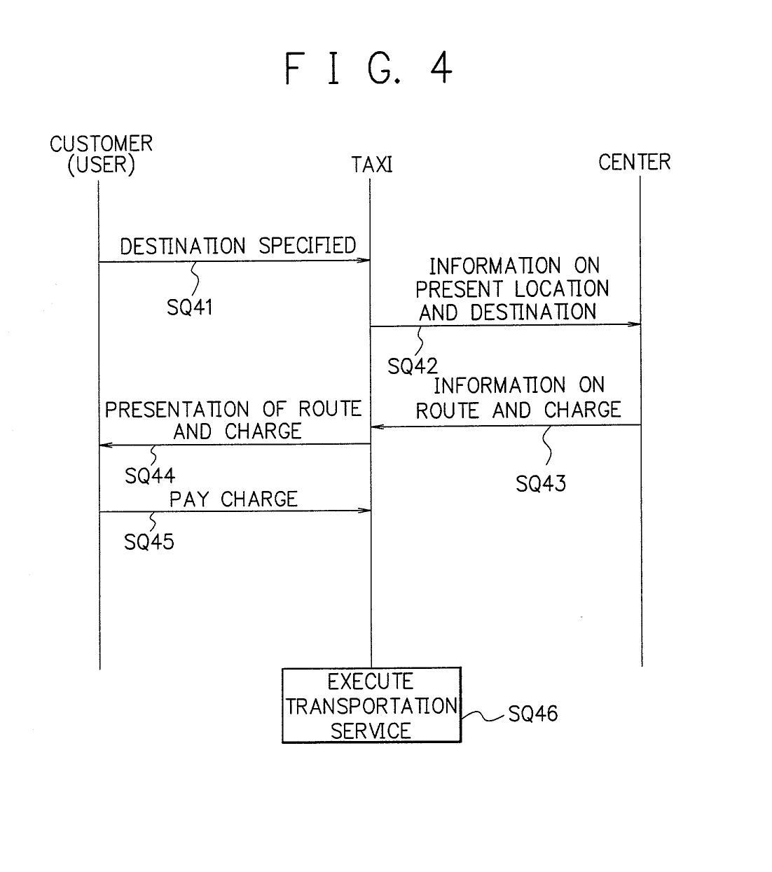

Referring now to FIGS. 1 to 4, a detailed description of operation of a system according to a first embodiment of the present invention will be given. FIG. 4 is a sequence diagram illustrating the operation of the first embodiment system.

When a passenger gets in the taxi 12 and notifies a driver a desired destination, the driver inputs the destination from the input section 23 (sequence SQ 41). The inputted destination information is sent to the controller 26 which generates present-location information indicating controller's present location at that time, according the information received from the GPS satellite 11. The controller 26 then transmits the present-location information together with the destination information to the portable telephone terminal 27.

Upon reception of the present-location information and the destination information from the controller 26, the portable telephone terminal 27 sends these items of information to the center equipment 16 via the portable telephone network 13 and the Internet 15 (SQ 42). The communication controller 32 of the center equipment 16 receives that information via the Internet 15. The information received is then fed to the controller 34. The controller 34 reads from the map information storage section 33 map information corresponding to the present-location information and the destination information, obtains ITS information from the ITS information receiver 35, and reads service-charge information from the preset charge information storage section 31. The controller 34 therefore finds an optimal route, and calculates a distance, a required traveling time, and a charge associated with the route.

The controller 34 thereafter adds address information of the portable telephone terminal 27 to information which includes the optimal route found, and the calculated distance, required traveling time, and charge. The resultant information is sent from the communication controller 32 to the Internet 15 (SQ 43).

In the taxi 12, the portable telephone terminal 27 receives the information sent from the center equipment 16 and passes the information to the controller 26 of the GPS terminal 20. On receipt of the information from the telephone terminal 27, the controller 26 reads from the map information storage section 25 map information corresponding to an optimal route contained in the information. The display section 24 then displays distance information, time information, and charge information, where the optimal route is superposed on a map given by the map information.

A taxi driver explains to a passenger in advance about a transportation service to be provided, by showing the passenger a screen image displayed on the display 24 (SQ 44). The passenger pays a charge indicated by the display 24 before the transportation service is started (SQ 45). Upon completion of the payment, the service is provided by the taxi 12 (SQ 46). It should be noted that the present invention system is capable of corresponding to any conventional payment method, including payment by cash, direct debit from a designated bank account, a credit card, and the like.

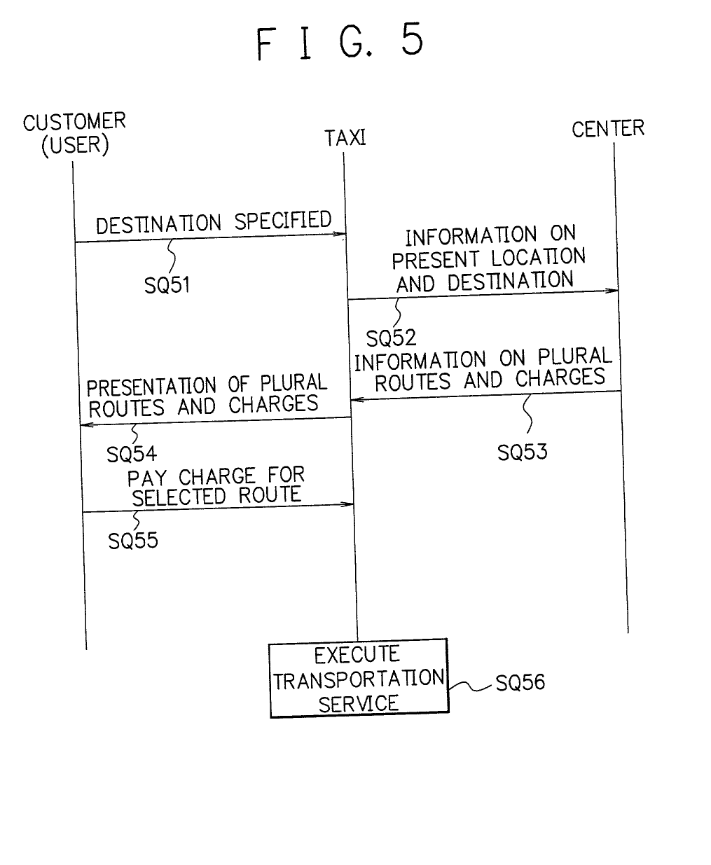

Description will now be given of operation of a system according to a second embodiment of the present invention, by referring to FIGS. 1, 2, 3, and 5. FIG. 5 is a sequence diagram illustrating the operation of the first embodiment system.

Similar to the first embodiment, when a passenger gets in the taxi 12 and notifies a driver a desired destination, the driver inputs the destination from the input section 23 (sequence SQ 51 of FIG. 5). After the inputted destination information is sent to the controller 26, it generates present-location information indicating controller's present location at that time, according the information received from the GPS satellite 11. The controller 26 then transmits the present-location information together with the destination information to the portable telephone terminal 27.

On receipt of the present-location information and the destination information from the controller 26, the portable telephone terminal 27 sends these items of information to the center equipment 16 via the portable telephone network 13 and the Internet 15 (SQ 52). In the center equipment 16, the communication controller 32 receives the information via the Internet 15. The received information is then fed to the controller 34. The controller 34 reads from the map information storage section 33 map information corresponding to the present-location information and the destination information, obtains ITS information from the ITS information receiver 35, and reads service-charge information from the preset charge information storage section 31. The controller 34 therefore finds and calculates depending upon different criteria, a plurality of optimal routes, a distance, a required traveling time, and a charge associated with these routes.

The controller 34 adds address information of the portable telephone terminal 27 to information which includes the optimal route found, and the calculated distance, required traveling time, and charge. The resultant information is sent from the communication controller 32 to the Internet 15 (SQ 53).

In the taxi 12, the portable telephone terminal 27 receives the information sent from the center equipment 16 and passes that information to the controller 26 of the GPS terminal 20. On receipt of the information from the telephone terminal 27, the controller 26 reads from the map information storage section 25 map information corresponding to an optimal route contained in the information. The display section 24 then displays distance information, time information, and charge information regarding respective optimal routes. At the same time, the display section 24 superposes the optimal route on a map given by the map information.

A taxi driver explains to a passenger in advance about a transportation service to be provided, by showing the passenger a screen image displayed on the display 24 (SQ 54). Before the transportation service is started, the passenger selects a route from among the plurality of routes which is most suitable for his or her demand, and pays a charge indicated by the display 24 (SQ 44). The service is provided by the taxi 12, if the passenger pays the charge (SQ 56).

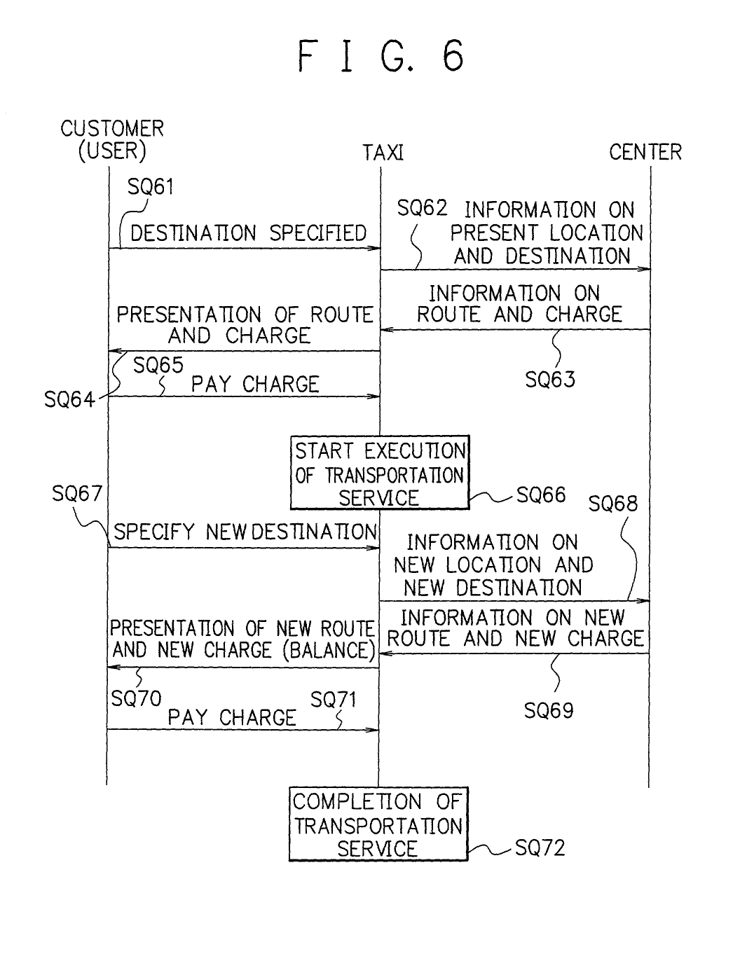

Referring now to FIGS. 1 to 3, and 6 a detailed description of operation of a system according to a third embodiment of the present invention will be given. FIG. 6 is a sequence diagram illustrating the operation of the third embodiment system.

When a passenger gets in the taxi 12 and notifies a driver a desired destination, the driver inputs the destination using the input section 23 (sequence SQ 61 of FIG. 6). The destination information inputted is sent to the controller 26 which generates present-location information indicating controller's present location at that time, according the information received from the GPS satellite 11. The controller 26 then transmits the present-location information together with the destination information to the portable telephone terminal 27.

Upon reception of the present-location information and the destination information from the controller 26, the portable telephone terminal 27 sends these items of information to the center equipment 16 via the portable telephone network 13 and the Internet 15 (SQ 62). The communication controller 32 of the center equipment 16 receives that information via the Internet 15. The information received is then fed to the controller 34. The controller 34 reads from the map information storage section 33 map information corresponding to the present-location information and the destination information, obtains ITS information from the ITS information receiver 35, and reads service-charge information from the preset charge information storage section 31. The controller 34 therefore finds and calculates an optimal route, a distance, a required traveling time, and a charge associated with the route.

The controller 34 thereafter adds address information of the portable telephone terminal 27 to information which includes the optimal route found, and the calculated distance, required traveling time, and charge. The resultant information is sent from the communication controller 32 to the Internet 15 (SQ 63).

The portable telephone terminal 27 in the taxi 12 receives the information sent from the center equipment 16 and passes the information to the controller 26 of the GPS terminal 20. On receipt of the information from the telephone terminal 27, the controller 26 reads from the map information storage section 25 map information corresponding to an optimal route contained in the information. The display section 24 then displays distance information, time information, and charge information, where the optimal route is superposed on a map given by the map information.

A taxi driver explains to a passenger in advance about a transportation service to be provided, by showing the passenger a screen image displayed on the display 24 (SQ 64). The passenger pays a charge indicated by the display 24 before the transportation service is started (SQ 65). Upon completion of the payment, the service is provided by the taxi 12 (SQ 66).

When a passenger changes the destination while the transportation service is being provided, the driver inputs the new destination from the input unit 23 (SQ 67). After information regarding the new destination is fed to the controller 26, it generates information on its own present location in accordance with information received at that time via the GPS satellite 11. The resultant information, that is the present-location information is sent to the portable telephone terminal 27 together with the destination information.

Upon reception of new present-location information and new destination information from the controller 26, the portable telephone terminal 27 transmits these items of information to the center equipment 16 via the portable telephone network 13 and the Internet 15 (SQ 68). The communication controller 32 of the center equipment 16 receives that information via the Internet 15 and sends it to the controller 34.

The controller 34 reads out from the map information storage section 33 map information corresponding to the new present-location information and destination information, and at the same time the controller acquires ITS information from the ITS information receiver 35 and reads service-charge information from the preset charge information storage section 31. The controller 34 thereby finds an optimal route, and calculates a distance, a required traveling time, and a charge associated with the route.

The controller 34 adds address information of the portable telephone terminal 27 to information which includes the newly found optimal route, and the newly calculated distance, required traveling time, and charge. The resultant information is sent from the communication controller 32 to the Internet 15 (SQ 69).

The portable telephone terminal 27 in the taxi 12 receives the information sent from the center equipment 16 and passes that information to the controller 26 of the GPS terminal 20. On receipt of the information from the telephone terminal 27, the controller 26 reads from the map information storage section 25 map information corresponding to the new optimal route contained in the information. The display section 24 then displays newly obtained distance information, time information, and charge information, where the new optimal route is superposed on a map given by the map information.

A taxi driver explains to a passenger about a transportation service to be provided, by showing the passenger a screen image displayed on the display 24 (SQ 70). The passenger pays a charge indicated by the display 24 before the transportation service is started (SQ 71). Upon completion of the payment, the service is again provided by the taxi 12 (SQ 72).

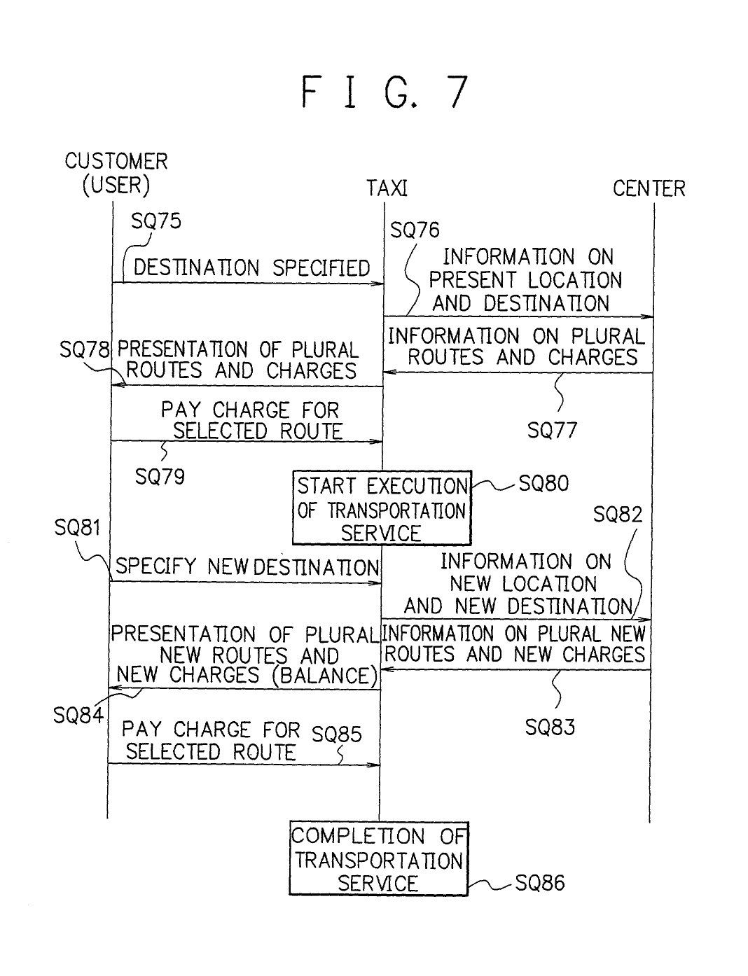

Description will now be given of operation of a system according to a fourth embodiment of the present invention, by referring to FIGS. 1 to 3, and 7. FIG. 7 is a sequence diagram illustrating the operation of the fourth embodiment system.

Similar to the second embodiment, when a passenger gets in the taxi 12 and notifies a driver a desired destination, the driver inputs the destination from the input section 23 (sequence SQ 75). After the inputted destination information is sent to the controller 26, it generates present-location information indicating controller's present location at that time, according the information received from the GPS satellite 11. The controller 26 then transmits the present-location information together with the destination information to the portable telephone terminal 27.

After receiving the present-location information and the destination information from the controller 26, the portable telephone terminal 27 sends these items of information to the center equipment 16 via the portable telephone network 13 and the Internet 15 (SQ 76). In the center equipment 16, the communication controller 32 receives the information via the Internet 15. The received information is then fed to the controller 34. The controller 34 reads from the map information storage section 33 map information corresponding to the present-location information and the destination information, obtains ITS information from the ITS information receiver 35, and reads service-charge information from the preset charge information storage section 31. The controller 34 therefore finds and calculates depending upon different criteria, a plurality of optimal routes, a distance, a required traveling time, and a charge associated with these routes.

The controller 34 adds address information of the portable telephone terminal 27 to information which includes the optimal route found, and the calculated distance, required traveling time, and charge. The resultant information is sent from the communication controller 32 to the Internet 15 (SQ 77).

In the taxi 12, the portable telephone terminal 27 receives the information sent from the center equipment 16 and passes that information to the controller 26 of the GPS terminal 20. On receipt of the information from the telephone terminal 27, the controller 26 reads from the map information storage section 25 map information corresponding to an optimal route contained in the information. The display section 24 then displays distance information, time information, and charge information for every optimal route. At the same time, the display section 24 superposes the optimal route on a map given by the map information.

A taxi driver explains to a passenger in advance about a transportation service to be provided, by showing the passenger a screen image displayed on the display 24 (SQ 78). Before the transportation service is started, the passenger selects a route from among the plurality of routes which is most suitable for his or her demand, and pays a charge indicated by the display 24 (SQ 79). The taxi 12 starts providing the service, if the passenger pays the charge (SQ 80).

In a case where a passenger changes the destination while the transportation service is being provided, the driver inputs the new destination from the input unit 23 (SQ 81). After information regarding the new destination is fed to the controller 26, it generates information on its own present location in accordance with information received at that time via the GPS satellite 11. The resultant information (present-location information) is sent to the portable telephone terminal 27 together with the destination information.

Upon reception of new present-location information and new destination information from the controller 26, the portable telephone terminal 27 transmits these items of information to the center equipment 16 via the portable telephone network 13 and the Internet 15 (SQ 82). The communication controller 32 of the center equipment 16 receives that information via the Internet 15 and sends it to the controller 34.

The controller 34 reads out from the map information storage section 33 map information corresponding to the new present-location information and destination information, and at the same time the controller acquires ITS information from the ITS information receiver 35 and reads service-charge information from the preset charge information storage section 31. The controller 34 thereby finds plural optimal routes depending upon respective different criteria, and calculates a distance, a required traveling time, and a charge associated with these routes.

The controller 34 adds address information of the portable telephone terminal 27 to information which includes the newly found optimal route, and the newly calculated distance, required traveling time, and charge. The resultant information is sent from the communication controller 32 to the Internet 15 (SQ 83).

The portable telephone terminal 27 in the taxi 12 receives the information sent from the center equipment 16 and passes that information to the controller 26 of the GPS terminal 20. On receipt of the information from the telephone terminal 27, the controller 26 reads from the map information storage section 25 map information corresponding to the new optimal route contained in the information. The display section 24 then displays newly obtained distance information, time information, and charge information, where the new optimal route is superposed on a map given by the map information.

A taxi driver explains to a passenger about a transportation service to be provided, by showing the passenger a screen image displayed on the display 24 (SQ 84). The passenger pays a charge indicated by the display 24 before the transportation service is started (SQ 85). Upon completion of the payment, the service is again provided by the taxi 12 (SQ

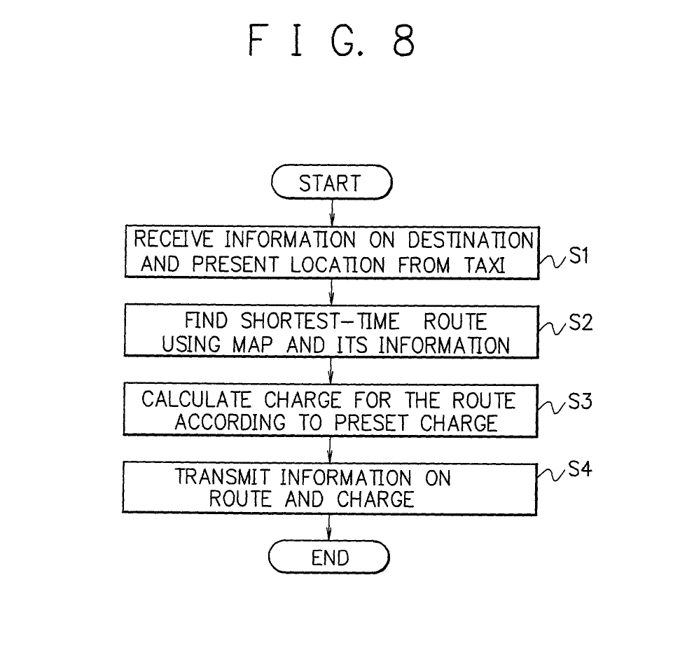

Next, description will be given in detail of operation of the controller 34 of the server 30 equipped in the center equipment 16 according to the first embodiment. FIG. 8 is a flowchart illustrating operation of the controller 34 according to the first embodiment.

In step S1 of FIG. 8, when the controller 34 receives from the communication controller 32 information (that is, present-location information and destination information) which have been sent from the taxi 12, the controller 34 reads from the map information storage section 33 map information associated with the present-location information and destination information, thus determining a plurality of routes connecting the present location and the destination.

The controller 34 acquires latest ITS information received by the ITS information receiver 35, and determines from among a plurality of routes an optimal route which is a shortest-time route requiring a shortest driving time, according to the map information and the ITS information. The controller 34 then generates distance information regarding a shortest-distance route based on the map information (step S2).

In step S3, the controller 34 reads service-charge information from the preset charge information storage section 31, and generates charge information on the shortest-distance route according to the service-charge information. In the next step, step S4, the controller 34 adds address information of the portable telephone terminal 27 to information including the shortest-time route information, the distance information, and the charge information, and transmits that information from the communication controller 32 to the Internet 15.

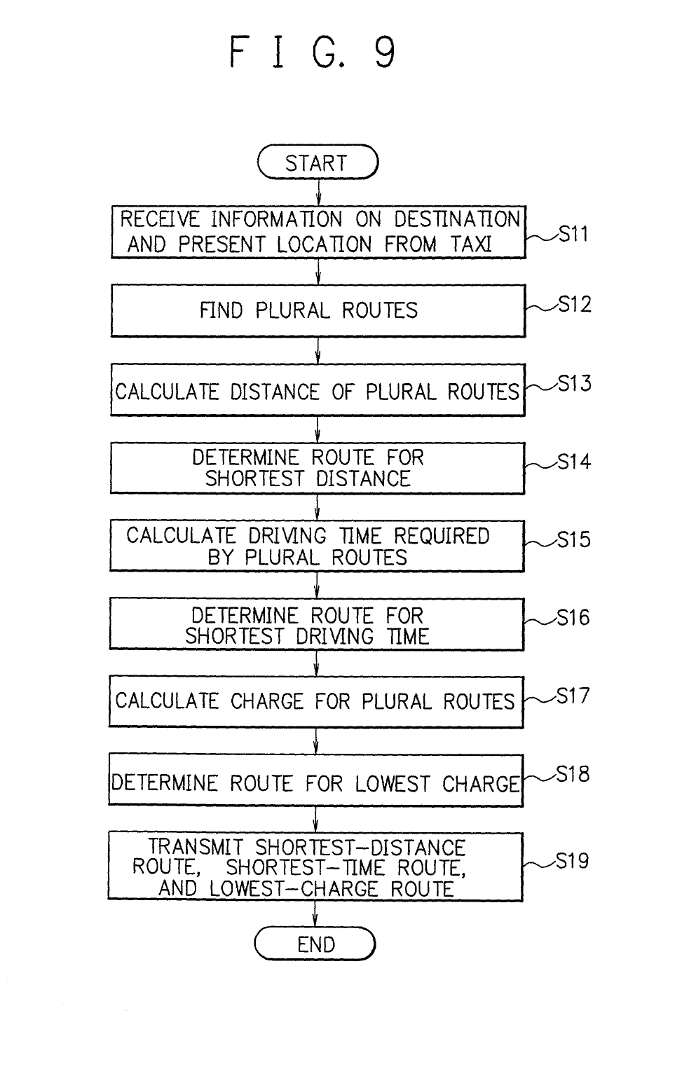

Description will now be given in detail of operation of the controller 34 of the server 30 equipped in the center equipment 16 according to the second embodiment. FIG. 9 is a flowchart illustrating operation of the controller 34 according to the second embodiment.

When the controller 34 receives from the communication controller 32 information (present-location information and destination information) which have been sent from the taxi 12, the controller 34 reads from the map information storage section 33 map information corresponding to the present-location information and destination information (step S11), thus determining a plurality of routes connecting the present location and the destination (step S12). The controller 34 calculates a distance between the present location and the destination for each of the routes, according to the map information (step S13). The controller 34 then determines one of the plural routes an optimal route which is a shortest-distance route having the shortest distance (step S14).

The controller 34 acquires latest ITS information received by the ITS information receiver 35, and calculates a required driving time for each route according to the map information and the ITS information (step S15). The controller 34 then determines one of the routes as an optimal route which is a shortest-time route requiring the shortest required driving time (step S16).

In step S17, the controller 34 reads service-charge information from the preset charge information storage section 31, and generates charge information for each of the routes according to the service-charge information. The controller 34 determines one of the routes as an optimal route which is a lowest-charge route requiring the lowest charge (step S18).

In the next step, the controller 34 adds address information of the portable telephone terminal 27 to information including information on the shortest-distance route and its time information, information on the shortest-time route and its time information, and information on the lowest-charge route and its charge information. The controller 34 then transmits the information from the communication controller 32 to the Internet 15 (step S19).

Accordingly, a passenger visually checks plural optimal routes and associated information presented on the display 24, and selects the route which is most suitable for his or her demand. The passenger pays a charge for the selected optimal route before the transportation service is provided. Upon completion of the payment, the transportation service is provided by the taxi 12.

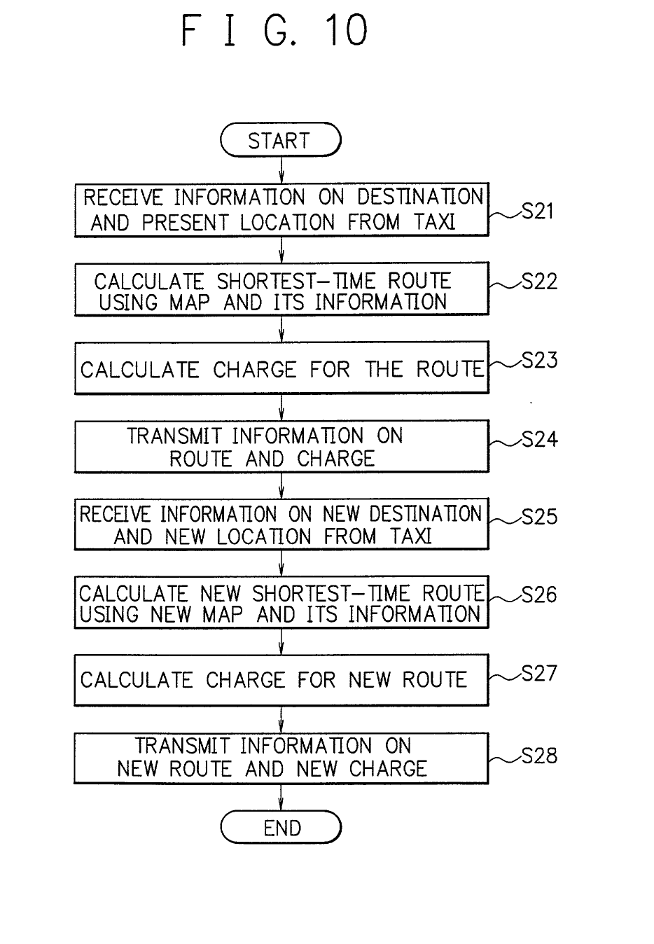

Description will be given in detail of operation of the controller 34 of the server 30 equipped in the center equipment 16 according to the third embodiment. FIG. 10 is a flowchart illustrating operation of the controller 34 according to the third embodiment.

When the controller 34 receives from the communication controller 32 information (present-location information and destination information) which have been sent from the taxi 12, the controller 34 reads from the map information storage section 33 map information associated with the present-location information and destination information (step S21), thus determining a plurality of routes connecting the present location and destination. The controller 34 also generates distance information regarding each distance between the present location and the destination, based upon the map information.

The controller 34 acquires latest ITS information received by the ITS information receiver 35, and determines from among the plurality of routes an optimal route which is a shortest-time route requiring the shortest required driving time, according to the map information and the ITS information. The controller 34 then generates distance information regarding a shortest-distance route based on the map information (step S22).

The controller 34 reads in step S23 service-charge information from the preset charge information storage section 31, and generates charge information on the shortest-distance route according to the service-charge information. In the next step, step S24, the controller 34 adds address information of the portable telephone terminal 27 to information including the shortest-time route information, the distance information, and the charge information, and transmits that information from the communication controller 32 to the Internet 15.

In a case where a passenger changes the destination while the transportation service is being provided, the driver inputs the new destination from the input unit 23. After information regarding the new destination is fed to the controller 26, it generates information on its own present location in accordance with information received at that time via the GPS satellite 11. The resultant information (present-location information) is sent to the portable telephone terminal 27 together with the destination information.

Upon reception of new present-location information and new destination information from the controller 26, the portable telephone terminal 27 transmits these items of information to the center equipment 16 via the portable telephone network 13 and the Internet 15. The communication controller 32 of the center equipment 16 receives that information via the Internet 15 and sends it to the controller 34.

When the controller 34 receives in step S25, from the communication controller 32, new information (new present-location information and new destination information) which have been sent from the taxi 12, the controller 34 reads from the map information storage section 33 map information corresponding to the present-location information and destination information, thus determining a plurality of routes connecting the present location and the destination.

The controller 34 acquires latest ITS information received by the ITS information receiver 35, and calculates a required driving time for each route according to the new map information and the new ITS information. The controller 34 then determines one of the plural routes as an optimal route which is a shortest-time route requiring the shortest required driving time (step S26).

The controller 34 reads in step S27 service-charge information from the preset charge information storage section 31, and generates charge information on the shortest-distance route according to the service-charge information. In step S28, the controller 34 adds address information of the portable telephone terminal 27 to information including the shortest-time route information, the distance information, and the charge information, and transmits that information from the communication controller 32 to the Internet 15.

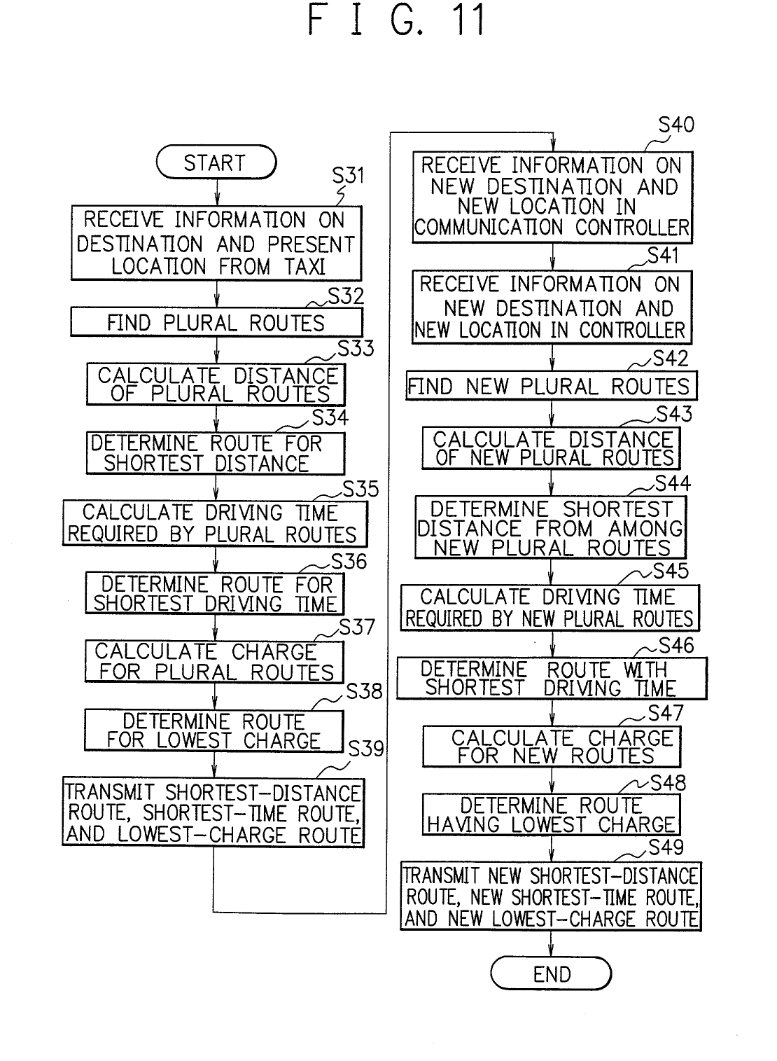

Description will now be given in detail of operation of the controller 34 of the server 30 equipped in the center equipment 16 according to the fourth embodiment. FIG. 11 is a flowchart illustrating operation of the controller 34 according to the fourth embodiment.

Similar to the operation as performed in the second embodiment system, when the controller 34 receives from the communication controller 32 information (present-location information and destination information) which have been sent from the taxi 12, the controller 34 reads from the map information storage section 33 map information corresponding to the present-location information and destination information (step S31), thus determining a plurality of routes connecting the present location and the destination (step S32). The controller 34 calculates a distance between the present location and the destination for each of the routes, according to the map information (step S33). The controller 34 then determines one of the plural routes as an optimal route which is a shortest-distance route having the shortest distance (step S34).

The controller 34 acquires latest ITS information received by the ITS information receiver 35, and calculates a required driving time for each route according to the map information and the ITS information (step S35). The controller 34 then determines one of the routes as an optimal route which is a shortest-time route requiring the shortest required driving time (step S36).

The controller 34 reads in step S37 service-charge information from the preset charge information storage section 31, and generates charge information for each of the routes according to the service-charge information. The controller 34 determines one of the routes as an optimal route which is a lowest-charge route requiring the lowest charge (step S38).

In the next step, the controller 34 adds address information of the portable telephone terminal 27 to information including information on the shortest-distance route and its time information, information on the shortest-time route and its time information, and information on the lowest-charge route and its charge information. The controller 34 then transmits the information from the communication controller 32 to the Internet 15 (step S39).

A passenger therefore visually checks plural optimal routes and their associated information presented on the display 24, and selects the route which is most suitable for his or her demand. The passenger pays a charge for the selected optimal route before the transportation service is provided. Upon completion of the payment, the transportation service is provided by the taxi 12.

If a passenger changes the destination while the transportation service is being provided, the driver inputs the new destination from the input unit 23. After information regarding the new destination is fed to the controller 26, it generates information on its own present location in accordance with information received at that time via the GPS satellite 11. The resultant information (present-location information) is sent to the portable telephone terminal 27 together with the destination information.

Upon reception of new present-location information and new destination information from the controller 26, the portable telephone terminal 27 transmits these items of information to the center equipment 16 via the portable telephone network 13 and the Internet 15. The communication controller 32 of the center equipment 16 receives in step S40 that information via the Internet 15 and sends it to the controller 34.

When the controller 34 receives in step S41 from the communication controller 32 new information (new present-location information and new destination information) which have been sent from the taxi 12, the controller 34 reads from the map information storage section 33 map information corresponding to the present-location information and destination information

The controller 34 determines in step S42 a plurality of routes connecting the present location and the destination based on the new map information. The controller 34 then calculates a distance between the new present location and the new destination for each of the routes, according to the map information (step S43), and determines one of the plural routes as an optimal route which is a shortest-distance route having the shortest distance (step S44).

The controller 34 acquires latest ITS information received by the ITS information receiver 35, and calculates a required driving time for each route according to the new map information and the ITS information (step S45). The controller 34 then determines one of the routes as an optimal route which is a shortest-time route requiring the shortest required driving time (step S46).

The controller 34 reads in step S47 service-charge information from the preset charge information storage section 31, and generates charge information for each of the routes according to the service-charge information. After that the controller 34 determines one of the routes as an optimal route which is a lowest-charge route requiring the lowest charge (step S48).

In the next step, the controller 34 adds address information of the portable telephone terminal 27 to information including information on the shortest-distance route and its time information, information on the shortest-time route and its time information, and information on the lowest-charge route and its charge information. The controller 34 then transmits the information from the communication controller 32 to the is Internet 15 (step S49).

A passenger therefore visually checks plural optimal routes and their associated information newly presented on the display 24, and reselects the route which is most suitable for his or her demand. The passenger pays a charge for the selected optimal route before the transportation service is provided. Upon completion of the payment, the transportation service is provided by the taxi 12.

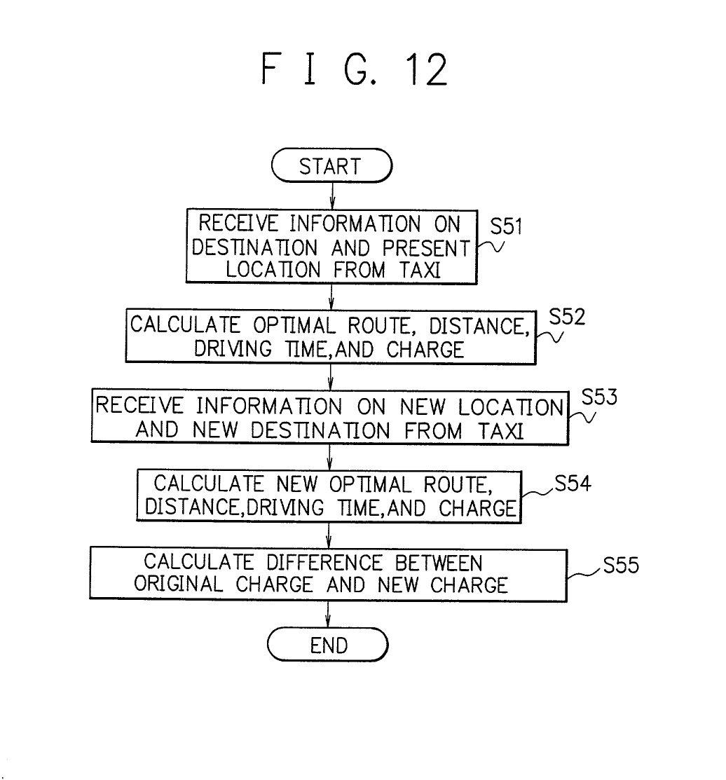

By referring to FIG. 12, description will be given in detail of a charge calculation operation performed by the controller 34 according to the third and fourth embodiments. FIG. 12 is a flowchart showing by way of example the charge calculation operation performed by the controller 34 according to the third embodiment.

In the third embodiment, the communication controller 32 receives the present-location information and the destination information sent from the taxi 12 and passes the received information to the controller 34 (step S51). As described above, the controller 34 reads from the map information storage section 33 map information corresponding to the received present-location information and destination information. Furthermore the controller 34 acquires ITS information from the ITS information receiver 35, and reads service-charge information from the preset charge information storage section 31. The controller 34 resultantly finds an optimal route, and calculates a distance, a required traveling time and a charge associated with the found route (step S52).

When there is a change in the destination by a passenger while the transportation service is being provided, the taxi 12 sends the new destination information and new present-location information at that time, which are received by the controller 34 (step S53). Similarly, the controller 34 reads from the map information storage section 33 map information corresponding to the received new present-location information and the new destination information. The controller 34 also acquires latest ITS information from the ITS information receiver 35, and reads service-charge information from the preset charge information storage section 31, thus resultantly finding an optimal route, and calculating a distance and a required traveling time associated with the optimal route (step S54).

The controller 34 subtracts a charge for a route from the new present location to the original destination, from the originally calculated charge. The controller 34 then adds a charge for a route from the new present location to the new destination, to the subtraction result. In the course of calculating the charge for a route from the new present location to the original destination, the controller 34 uses the original map information and the original ITS information. In the operation to calculate the charge for a route from the new present location to the new destination, the new map information and the new ITS information are utilized.

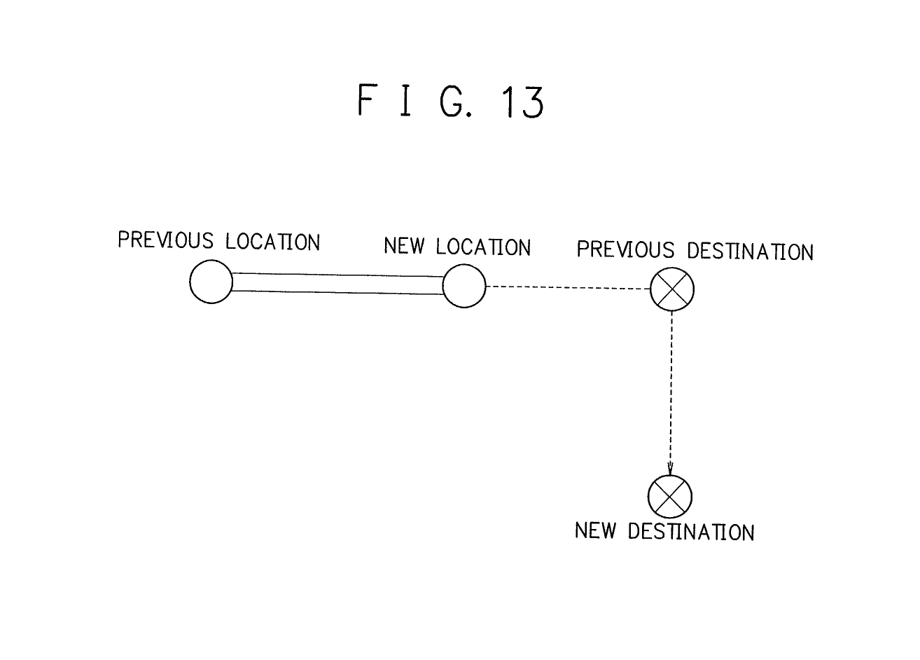

FIG. 13 shows a diagram in which the new present location is indicated as a new location, the original destination as a previous destination, the new destination as a new destination, and the former present location as a previous location.

If a charge for the new route is calculated by the controller 34, it also calculates a difference in charge (balance) between the original charge already paid by the passenger and the new charge (step S55). New charge information to which information on the balance is added is sent to the taxi 12.

For the fourth embodiment, the same processing as described above for the third embodiment can be applied. Specifically, by calculating a new charge for each of a plurality of routes based on the new present-location information and the new destination information, information on balance with respect to the original charge can be obtained. The passenger therefore pays for the balance presented on the display 24 or it is paid back to him or her, before the service is provided again.

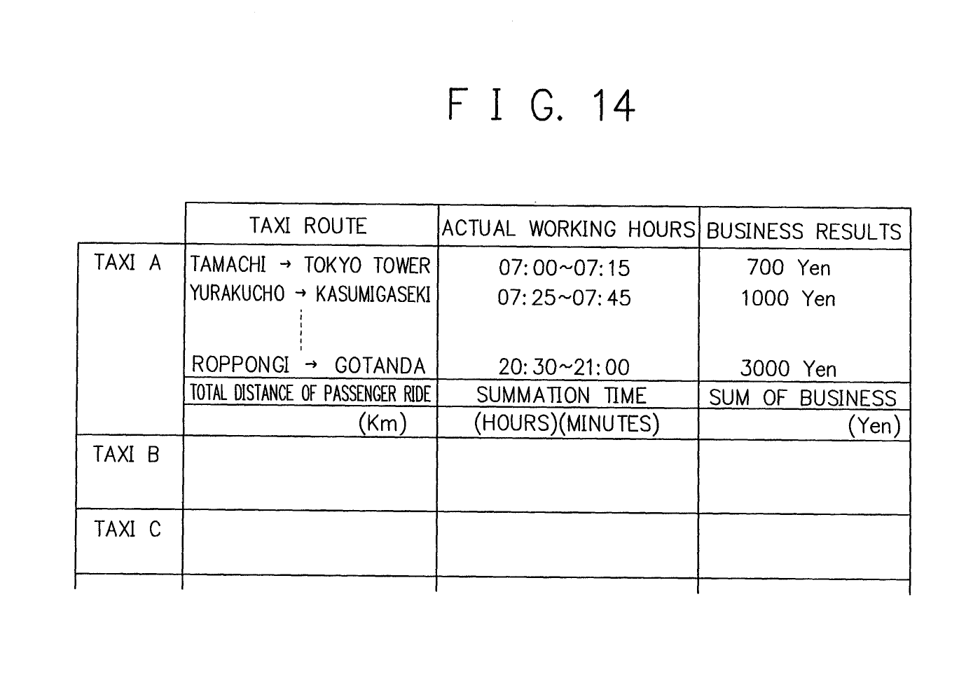

In the present embodiments, the center equipment 16 is capable of managing business results achieved by each taxi. Referring to the drawing, description will be given of a management method of each taxi executed by the center equipment 16. FIG. 14 is a table showing by way of example a management method of business results for each taxi performed by the center equipment 16.

As shown in FIG. 14, in this management method, taxis to which numbers are assigned are classified according to the telephone number of a portable telephone terminal possessed by each taxi. Taxi route, actual working hours, and business results are managed for each taxi. The taxi route indicates a route and its distance with respect to a transportation service provided by the tax, which respectively correspond to an optimal route and a distance thereof calculated according to received present-location information and destination information.

Actual working hours indicate hours actually worked by the taxi, which corresponds to a time period, for example, from the time when the center equipment receives the present-location information and destination information and to the time when the taxi arrives at the destination. Arrival time to the destination is notified to the center equipment by a portable telephone terminal, if a driver inputs the arrival time from the input unit when he or she arrives at the destination.

Business results indicate sales proceeds done by the taxi. In the present invention, charge is calculated by the center equipment and a passenger pays for the charge, before the transportation service is provided. Therefore, charge information generated by the center equipment corresponds to the business results.

It is noted that the management items are shown in the table only by way of example according to the present invention, and are subject to be changed within the scope of the present invention.

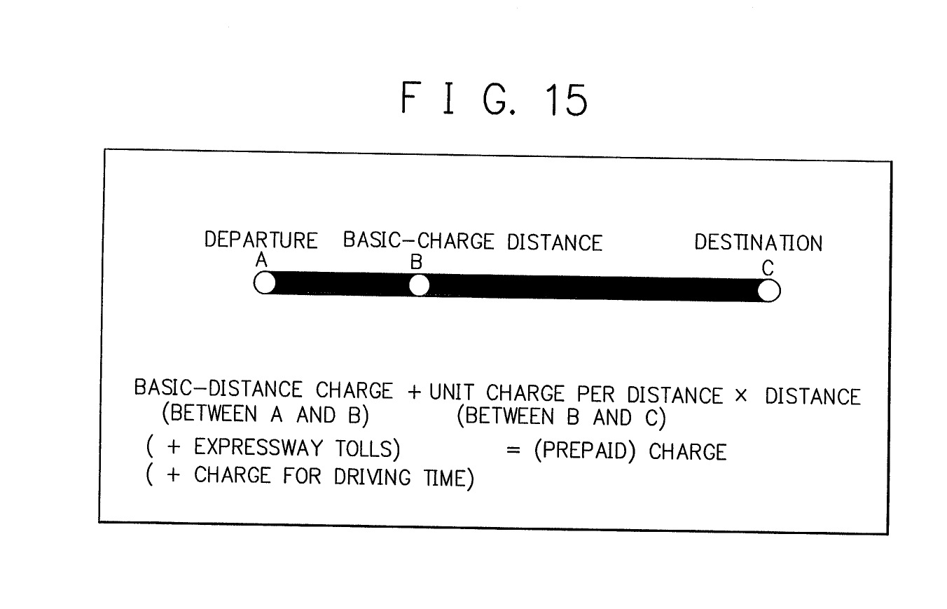

Service information stored in the preset charge information storage section 31 includes as shown in FIG. 15, a charge for driving a unit distance from point A to point B, a unit charge per distance in which a charge is added to every time a taxi runs a unit distance. Moreover, service information may include, for example, expressway tolls to be charged when a taxi uses an expressway, and a driving-time charge specified by a unit time to be added to at a fixed time interval.

As can be understood from the above description, in the present invention system, the function to find an optimal route based on the present location to the destination is allocated to the center equipment to control taxis in a centralized manner. This makes a taxi company realize the cost savings, and at the same time it makes easy business administration for each taxi.

According to the present invention, it is possible to present to a passenger a charge required for a transportation service and the like, before the service is provided. The passenger can therefore order the service at ease. Furthermore, by presenting that charge to a passenger as a transportation service charge and by receiving the charge from the passenger before the service is provided, the taxi company can avoid disbenefit caused by, say a free ride.

In the present invention, the center equipment finds depending upon different criteria a plurality of optimal routes which connect the present location to the destination, a passenger can therefore select an optimal route most suitable for his or her demand.

Furthermore, according to the present invention, even when a passenger changes the destination while the transportation service is being provided, the center equipment can find an optimal route and a charge for the route in conformity with the new destination. Accordingly, the transportation service can be provided without causing any operational problem to the new charge as well as business administration in the taxi company.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A transportation service system, comprising:
at least one Global Positioning System (GPS) satellite for transmitting information used to detect a position of a moving object;
at least one taxi having a GPS terminal which receives said information from said GPS satellite and detects a present location of said taxi on the basis of said information, for transmitting present-location information regarding said detected present location and destination information indicating a destination specified by a customer; and
a center equipment for receiving said present-location information and destination information, for finding an optimal route to obtain optimal-route information in accordance with said present-location information and destination information, and for transmitting information including said optimal-route information to said taxi.

2. A transportation service system according to claim 1, wherein said center equipment calculates in accordance with said present-location information and destination information a charge for said optimal route to obtain charge information, and transmits information including said charge information to said taxi.

3. A transportation service system according to claim 2, wherein said center equipment calculates in accordance with said present-location information and destination information a distance from said present location to said destination associated with said optimal route to obtain distance information, and transmits information including said distance information to said taxi.

4. A transportation service system according to claim 3, wherein said center equipment calculates in accordance with said present-location information and destination information a required driving time associated with said optimal route to obtain driving time information, and transmits information including said driving time information to said taxi.

5. A transportation service system according to claim 4, wherein, if the customer changes the destination to a new destination when a service is being provided by said taxi,
said taxi detects by said GPS terminal new present-location information at the time of said change, and transmits to said center equipment said detected new present-location information and new destination information indicating said new destination, and
said center equipment finds in accordance with said new present-location information and new destination information a new optimal route to obtain new optimal-route information, and transmits information including said new optimal-route information to said taxi.

6. A transportation service system according to claim 5, wherein said center equipment calculates in accordance with said new present-location information and new destination information a charge for said new optimal route to obtain charge information, and transmits information including said charge information to said taxi.

7. A transportation service system according to claim 6, wherein said center equipment calculates in accordance with said new present-location information and new destination information a distance from said new present location to said new destination designated by said new optimal route to obtain distance information, and transmits information including said distance information to said taxi.

8. A transportation service system according to claim 7, wherein said center equipment calculates in accordance with said new present-location information and new destination information a required driving time required by said taxi, which is associated with said new optimal route, to obtain driving-time information, and transmits information including said driving-time information to said taxi.

9. A transportation service system, comprising:
at least one global positioning system (GPS) satellite for transmitting information used to detect a position of a moving object;
at least one taxi having a GPS terminal which receives said information from said GPS satellite and detects a present location of said taxi on the basis of said information, for transmitting present-location information regarding said detected present location and destination information indicating a destination specified by a customer; and
a center equipment for receiving said present-location information and destination information, for finding respective optimal routes for each of plural different items to obtain optimal-route information in accordance with said present-location information and destination information, and for transmitting information including said optimal-route information to said taxi.

10. A transportation service system according to claim 9, wherein said center equipment calculates in accordance with said present-location information and destination information a charge for each of said optimal routes to obtain charge information, and transmits information including said charge information to said taxi.

11. A transportation service system according to claim 10, wherein said center equipment calculates in accordance with said present-location information and destination information a distance from said present location to said destination associated with each of said optimal routes to obtain distance information, and transmits information including said distance information to said taxi.

12. A transportation service system according to claim 11, wherein said center equipment calculates in accordance with said present-location information and destination information a required driving time associated with each of said optimal routes to obtain driving time information, and transmits information including said driving time information to said taxi.

13. A transportation service system according to claim 12, wherein, if the customer changes the destination to a new destination when a service is being provided by said taxi,
said taxi detects by said GPS terminal new present-location information at the time of said change and transmits to said center equipment said detected new present-location information and new destination information indicating said new destination, and
said center equipment finds in accordance with said new present-location information and new destination information, respective new optimal routes for each of said plural different items to obtain new items of optimal-route information, and transmits information including each of said new items of optimal-route information to said taxi.

14. A transportation service system according to claim 13, wherein said center equipment calculates in accordance with said new present-location information and new destination information a charge for each of said respective new optimal routes to obtain charge information, and transmits information including said charge information to said taxi.

15. A transportation service system according to claim 14, wherein said center equipment calculates in accordance with said new present-location information and new destination information a distance from said new present location to said new destination associated with each of said respective new optimal routes to obtain distance information, and transmits information including said distance information to said taxi.

16. A transportation service system according to claim 15, wherein said center equipment calculates in accordance with said new present-location information and new destination information a required driving time required by said taxi, which is associated with each of said respective new optimal routes, to obtain driving-time information, and transmits information including said driving-time information to said taxi.

17. A transportation service system according to claim 16, wherein said plural different items include charges for said respective optimal routes, a distance from said present location to said destination associated with said respective optimal routes, and a required driving time required by said taxi associated with said respective optimal routes.

18. A transportation service system according to claim 4, wherein said center equipment comprises:
a server for communicating information with said taxi and executing a predetermined processing; and
Intelligent Transportation System (ITS) information receiving means connected to said server, for receiving ITS information offered by said ITS,
said server comprising;
first communication control means for communicating information with each of said at least one taxi;
first map-information storage means for storing map information for each area;
preset-charge storage means for storing service-charge information associated with a taxi company; and
first control means connected to each of said first communication control means, said first map-information storage means, and said preset-charge storage means, for controlling each of said means, wherein said first control means reads from said first map-information storage means map information corresponding to said destination information and said present-location information received by said first communication control means, obtains said ITS information from said ITS information receiving means, reads said service-charge information from said preset-charge storage means, and calculates in accordance with said map information, with said ITS information, and with said service-charge information, said optimal route, a distance from said present location to said destination associated with said optimal route, a required driving time associated with said optimal route, and a charge for said optimal route.

19. A transportation service system according to claim 18, wherein, if the customer changes the destination to a new destination when a service is being provided by said taxi,
said taxi transmits to said center equipment present-location information at the time of said change as new present-location information, and destination information indicating said new destination, in said center equipment;
said first communication control means receives said new present-location information and new destination information, and said first control means obtains new ITS information from said ITS information receiving means, reads from said first map-information storage means new map information corresponding to said new present-location information and said new destination information, and finds according to said new ITS information, to said new map information, and to said new service-charge information, a new optimal route, a distance from said new present location to said new destination designated by said new optimal route, a required driving time required by said taxi associated with said new optimal route, and a charge for said new optimal route.

20. A transportation service system according to claim 12, wherein said center equipment comprises:
a server for communicating information with said taxi and executing a predetermined processing; and
Intelligent Transportation System (ITS) information receiving means connected to said server, for receiving ITS information offered by said ITS;
said server having:
first communication control means for communicating information with each of said at least one taxi;
first map-information storage means for storing map information for each area;
preset-charge storage means for storing service-charge information associated with a taxi company; and
first control means connected to each of said first communication control means, first map-information storage means, and preset-charge storage means, for controlling each of said first communication control means, first map-information storage means, and preset-charge storage means,
wherein said first control means reads from said first map-information storage means map information corresponding to said destination information and said present-location information received by said first communication control means, obtains said ITS information from said ITS information receiving means, reads said service-charge information from said preset-charge storage means, and calculates for each of said plural different items, in accordance with said map information, with said ITS information, and with said service-charge information, said respective optimal routes, a distance from said present location to said destination associated with said respective optimal routes, a required driving time associated with said respective optimal routes, and charges for said respective optimal routes.

21. A transportation service system according to claim 20, wherein, if the customer changes the destination to a new destination when a service is being provided by said taxi,
said taxi transmits to said center equipment present-location information at the time of said change as new present-location information, and destination information indicating said new destination,
in said center equipment;
said first communication control means receives said new present-location information and new destination information, and said first control means obtains new ITS information from said ITS information receiving means, reads from said first map-information storage means new map information corresponding to said new present-location information and said new destination information, and finds for each of said plural different items, according to said new ITS information, to said new map information, and to said new service-charge information, new respective optimal routes, a distance from said new present location to said new destination designated by said new respective optimal routes, a required driving time required by said taxi associated with said new respective optimal routes, and charges for said new respective optimal routes.

22. A transportation service system according to claim 4, wherein said center equipment comprises:
a server for communicating information with said taxi and executing a predetermined processing; and
Intelligent Transportation System (ITS) information receiving means connected to said server, for receiving ITS information offered by said ITS,
said server comprising:
first communication control means for communicating information with each of said at least one taxi;
first map-information storage means for storing map information for each area;
preset-charge storage means for storing service-charge information associated with a taxi company; and
first control means connected to each of said first communication control means, first map-information storage means, and preset-charge storage means, for controlling each of said first communication control means, first map-information storage means, and preset-charge storage means,
wherein said first control means reads from said first map-information storage means map information corresponding to said destination information and said present-location information received by said first communication control means, obtains said ITS information from said ITS information receiving means, reads said service-charge information from said preset-charge storage means, finds according to said map information a plurality of routes connecting said present location and destination, calculates according to said ITS information a required driving time for each of said plurality of routes to determine that a shortest-time route among said plural routes having the shortest required driving time is said optimal route, calculates according to said map information a distance from said present location to said destination associated with said shortest-time route, calculates a charge for said shortest-time route according to said service-charge information, generates information including shortest-time route information indicative of said shortest-time route, distance information indicative of said distance, and charge information indicative of said charge, and transmits said generated information via said first communication control means to said taxi, by adding address information of said portable telephone terminal to said generated information.

23. A transportation service system according to claim 22, wherein, if the customer changes the destination to a new destination when a service is being provided by said taxi,
said taxi transmits to said center equipment present-location information at the time of said change as new present-location information, and destination information indicating said new destination, in said center equipment;
said first communication control means receives said new present-location information and new destination information, and sends said received information to said first control means, and said first control means obtains new ITS information from said ITS information receiving means, reads from said first map-information storage means new map information corresponding to said new present-location information and said new destination information, finds according to said new map information a plurality of routes connecting said new present location and new destination, calculates according to said ITS information a required driving time for each of said new plurality of routes to determine that a new shortest-time route among said new plural routes having the shortest required driving time is said optimal route, calculates according to said new map information a distance associated with said shortest-time route, calculates a charge for said new shortest-time route according to said service-charge information, generates information including new shortest-time route information indicative of said new shortest-time route, new distance information indicative of said distance, and new charge information indicative of said charge, and transmits said generated information via said first communication control means to said taxi, by adding address information of said portable telephone terminal to said generated information.

24. A transportation service system according to claim 12, wherein said center equipment comprises:
a server for communicating information with said taxi and executing a predetermined processing; and
Intelligent Transportation System (ITS) information receiving means connected to said server, for receiving ITS information offered by said ITS,
said server comprising:
first communication control means for communicating information with each of said at least one taxi;
first map-information storage means for storing map information for each area;
preset-charge storage means for storing service-charge information associated with a taxi company; and
first control means connected to each of said first communication control means, first map-information storage means, and preset-charge storage means, for controlling each of said first communication control means, first map-information storage means, and preset-charge storage means,
wherein said first control means reads from said first map-information storage means map information corresponding to said destination information and said present-location information received by said first communication control means, obtains said ITS information from said ITS information receiving means, reads said service-charge information from said preset-charge storage means, finds according to said map information a plurality of routes connecting said present location and destination, calculates according to said map information a distance from said present location to said destination associated with each of said plurality of routes to determine that a shortest-distance route among said plurality of routes is an optimal route having the shortest distance, calculates according to said ITS information a required driving time for each said plurality of routes to determine that a shortest-time route among said plurality of routes is an optimal route having the shortest required driving time, calculates according to said service-charge information a charge for each of said plurality of routes to determine that a lowest-charge route among said plurality of routes is an optimal route, generates information including information indicating said shortest-distance route and its associated distance, information indicating said shortest-time route and its associated time, and information indicating said lowest-charge route and its associated charge, and transmits said generated information via said first communication control means to said taxi by adding address information of said portable telephone terminal to said generated information.

25. A transportation service system according to claim 24, wherein, if the customer changes the destination to a new destination when a service is being provided by said taxi,
said taxi transmits to said center equipment present-location information at the time of said change as new present-location information, and destination information indicating said new destination,
in said center equipment;
said first communication control means receives said new present-location information and new destination information, and sends said received information to said first control means, and said first control means obtains new ITS information from said ITS information receiving means, reads from said first map-information storage means new map information corresponding to said new present-location information and said new destination information, reads said service-charge information from said preset-charge storage means, finds according to said new map information a plurality of routes connecting said new present location and new destination, calculates according to said ITS information a required driving time for each of said new plurality of routes to determine that a shortest-time route among said new plural routes having the shortest required driving time is said optimal route, calculates according to said new map information a distance from said new present location to said new destination associated with said new plural routes to determine that a shortest-distance route among said plurality of routes is one of said optimal routes having the shortest distance, calculates according to said service-charge information a charge for each of said plural routes to determine that a lowest-charge route among said plurality of routes is one of said optimal routes having the lowest charge, generates information including shortest-time route information indicative of said shortest-time route, shortest-distance route information indicative of said shortest-distance route, and lowest-charge route information indicative of said lowest-charge route, and transmits said generated information via said first communication control means to said taxi by adding address information of said portable telephone terminal to said generated information.

26. A transportation service system according to claim 23, wherein, if the customer changes the destination to a new destination when a service is being provided by said taxi, said first control means calculates a first charge for a route from said new present location to said destination according to said map information, said ITS information, and said service-charge information, calculates a second charge for a route from said new present location to said new destination according to said new map information, to said new ITS information, and to said service-charge information, subtracts said second charge from said first charge, and adds said second charge to said subtraction result to calculate said new charge.

27. A transportation service system according to claim 26, wherein said first control means calculates a balance between said first charge and said new charge, and transmits to said taxi information on said balance together with information regarding said first charge via said first communication control means.

28. A transportation service system according to claim 25, wherein, if the customer changes the destination to a new destination when a service is being provided by said taxi, said first control means calculates a first charge for a route from said new present location to said destination according to said map information, said ITS information, and said service-charge information, calculates a second charge for a route from said new present location to said new destination according to said new map information, to said new ITS information, and to said service-charge information, subtracts said second charge from said first charge, and adds said second charge to said subtraction result to calculate said new charge.

29. A transportation service system according to claim 28, wherein said first control means calculates a balance between said first charge and said new charge, and transmits to said taxi information on said balance together with information regarding said first charge via said first communication control means.

30. A transportation service system according to claim 22, wherein said taxi has said GPS terminal and second communication control means connected to said GPS terminal, for communicating information with said center equipment, said GPS terminal comprising;
input means for inputting a destination specified by the customer,
second map-information storage means for storing map information for each area,
image display means for displaying an image, and
second control means connected to said input means, second map-information storage means, and image display means, for controlling each of said means,
said second control means detecting said present-location information from radio waves received from said GPS satellite, and sending to said first communication control means said present-location information and destination information indicative of said destination inputted from said input means,
said second communication control means sending to said center equipment said present-location information and said destination information received from said second control means, and sending to said second control means information received from said center equipment,
and said second control means reading from said second map-information storage means map information corresponding to said optimal route included in information received from said second communication control means, displaying on said image display means said optimal route by superposing the route on said map information, and displaying a distance from said present location to said destination associated with said optimal route included in said information transmitted from said center equipment, a required driving time associated with said optimal route, and a charge for said optimal route.

31. A transportation service system according to claim 24, wherein said taxi has said GPS terminal and second communication control means connected to said GPS terminal, for communicating information with said center equipment, said GPS terminal comprising;
input means for inputting a destination specified by the customer,
second map-information storage means for storing map information for each area,
image display means for displaying an image, and
second control means connected to said input means, second map-information storage means, and image display means, for controlling each of said means,
said second control means detecting said present-location information from radio waves received from said GPS satellite, and sending to said first communication control means said present-location information and destination information indicative of said destination inputted from said input means,
said second communication control means sending to said center equipment said present-location information and said destination information received from said second control means, and sending to said second control means information received from said center equipment,
and said second control means reading from said second map-information storage means map information corresponding to said respective optimal routes for each of said plural different items included in information received from said second communication control means, displaying on said image display means said respective optimal routes by superposing the route on said map information, and displaying a distance from said present location to said destination associated with said respective optimal routes included in said information transmitted from said center equipment, a required driving time associated with said respective optimal routes, and charges for said respective optimal routes.

32. A transportation service system according to claim 30, wherein in said taxi, if the customer changes the destination to a new destination when a service is being provided by said taxi, said second communication control means receives new information sent from said center equipment, said second control means reads from said second map-information storage means new map information corresponding to said new optimal route included in said new information, and said image display means displays said new map information on which said new optimal route is superposed, and a distance from said new present location to said new destination associated with said new optimal route included in said new information, a required driving time associated with said new optimal route, and a charge for said new optimal route.

33. A transportation service system according to claim 31, wherein in said taxi, if the customer changes the destination to a new destination when a service is being provided by said taxi, said second communication control means receives new information sent from said center equipment, said second control means reads from said second map-information storage means new map information corresponding to said respective new optimal routes for each of said plural different items included in said new information, and said image display means displays said new map information on which said respective new optimal routes are superposed, and displays a distance from said new present location to said new destination associated with said respective new optimal routes included in said new information, a required driving time associated with said respective new optimal routes, and charges for said respective new optimal routes.

34. A transportation service system according to claim 32, wherein said center equipment administers information obtained for said optimal route for every taxi.

35. A transportation service system according to claim 33, wherein said center equipment administers information obtained for said new optimal route for every taxi.

36. A transportation service system according to claim 32, wherein, for every taxi, said center equipment administers said information obtained with respect to said respective optimal routes, which has been obtained for an optimal route selected by the customer from among said optimal routes.

37. A transportation service system according to claim 33, wherein, for every taxi, said center equipment administers said information obtained with respect to said respective new optimal routes, which has been obtained for an optimal route selected by the customer from among said new optimal routes.

38. A method of providing a transportation service in a system which comprises at least one Global Positioning System (GPS) satellite, a GPS terminal, a center equipment, and at least one taxi on which said GPS terminal is mounted, said method comprising the steps of
detecting by said GPS terminal its present location according to information for finding a position of a moving object transmitted from said GPS satellite;
transmitting from said taxi present-location information on said present location, and destination information indicating a destination specified by a customer; and
receiving by said center equipment said present-location information and said destination information, obtaining optimal-route information on an optimal route according to said present-location information and destination information, and transmitting information including said optimal-route information to said taxi.

39. A method of providing a transportation service according to claim 38, further including a step of calculating by said center equipment charge information on a charge for said optimal route according to said present-location information and destination information, and transmitting information including said charge information to said taxi.

40. A method of providing a transportation service according to claim 39, further including a step of paying by the customer a charge indicated by said charge information, before a transportation service is provided by said taxi.

41. A method of providing a transportation service according to claim 40, further including a step of obtaining by said center equipment distance information regarding a distance from said present location to said destination associated with said optimal route according to said present-location information and destination information, and transmitting said information including said distance information to said taxi.

42. A method of providing a transportation service according to claim 41, further including a step of obtaining by said center equipment driving-time information on a required driving time associated with said optimal route according to said present-location information and destination information, and transmitting information including said driving-time information to said taxi.

43. A method of providing a transportation service according to claim 42, wherein, if the customer changes the destination to a new destination when a service is being provided by said taxi, said taxi obtains by using said GPS terminal present-location information on a present location at the time of said change, and transmits to said center equipment said present-location information and destination information indicating said new destination, and wherein said center equipment obtains optimal-route information regarding a new optimal route according to said new present-location information and said new destination information, and transmits information including said optimal-route information to said taxi.

44. A method of providing a transportation service according to claim 43, said center equipment further obtains new charge information on a charge for said new optimal route according to said new present-location information and new destination information, and transmits said information including said new charge information to said taxi.

45. A method of providing a transportation service according to claim 44, the customer pays for a charge indicated by said new charge information, before said taxi provides a transportation service associated with said new destination.

46. A method of providing a transportation service according to claim 45, said center equipment further obtains distance information on a distance from said new present location to said new destination associated with said new optimal route according to said new present-location information and new destination information, and transmits said information including said distance information to said taxi.

47. A method of providing a transportation service according to claim 46, said center equipment further obtains driving-time information on a required driving time associated with said new optimal route according to said new present-location information and new destination information, and transmits said information including said driving-time information to said taxi.

48. A method of providing a transportation service in a system which comprises at least one Global Positioning System (GPS) satellite, a GPS terminal, a center equipment, and at least one taxi on which said GPS terminal is mounted, said method comprising the steps of
detecting by said GPS terminal its present location according to information for finding a position of a moving object transmitted from said GPS satellite;
transmitting from said taxi present-location information on said present location, and destination information indicating a destination specified by a customer; and
receiving by said center equipment said present-location information and said destination information, finding as information respective optimal routes for each of plural different items according to said present-location information and destination information, and transmitting information including said optimal-route information to said taxi.

49. A method of providing a transportation service according to claim 48, further including a step of calculating by said center equipment charge information on charges for said respective optimal routes according to said present-location information and destination information, and transmitting information including said charge information to said taxi.

50. A method of providing a transportation service according to claim 49, further including a step of selecting by the customer one of optimal routes before a transportation service is provided by said taxi, and paying a charge indicated by said charge information on said selected optimal route.

51. A method of providing a transportation service according to claim 50, further including a step of obtaining by said center equipment distance information regarding a distance from said present location to said destination associated with said respective optimal routes according to said present-location information and destination information, and transmitting said information including said distance information to said taxi.

52. A method of providing a transportation service according to claim 51, further including a step of obtaining by said center equipment driving-time information on a required driving time associated with said respective optimal routes according to said present-location information and destination information, and transmitting information including said driving-time information to said taxi.

53. A method of providing a transportation service according to claim 52, wherein, if the customer changes the destination to a new destination when a service is being provided by said taxi, said taxi obtains by using said GPS terminal present-location information on a present location at the time of said change, and transmits to said center equipment said present-location information and destination information indicating said new destination, and wherein said center equipment finds respective new optimal routes for each of said plural different items according to said new present-location information and said new destination information to obtain optimal-route information regarding a new optimal route, and transmits information including said optimal-route information to said taxi.

54. A method of providing a transportation service according to claim 53, said center equipment further obtains new charge information on charges for said respective new optimal routes according to said new present-location information and new destination information, and transmits said information including said new charge information to said taxi.

55. A method of providing a transportation service according to claim 54, the customer selects an optimal route from among said respective new optimal routes before said taxi provides a transportation service associated with said new destination, and pays for a charge indicated by charge information on said selected optimal route.

56. A method of providing a transportation service according to claim 55, said center equipment further obtains distance information on a distance from said new present location to said new destination associated with said respective new optimal routes according to said new present-location information and new destination information, and transmits said information including said distance information to said taxi.

57. A method of providing a transportation service according to claim 56, said center equipment further obtains driving-time information on a required driving time associated with said respective new optimal routes according to said new present-location information and new destination information, and transmits said information including said driving-time information to said taxi.

58. A method of providing a transportation service according to claim 57, wherein said plural different items include charges for said respective optimal routes, a distance from said present location to said destination associated with said respective optimal routes, and a required driving time required by said taxi associated with said respective optimal routes.

59. A method of providing a transportation service in a system which comprises at least one Global Positioning System (GPS) satellite, a GPS terminal, a portable telephone terminal, a center equipment, and at least one taxi on which said GPS terminal and portable telephone terminal are mounted, said center equipment having a communication controller, a controller, a map-information storage unit, a preset-charge information storage unit, and an ITS information receiver, said method comprising the steps of:
detecting by said GPS terminal its present location according to information for finding a position of a moving object transmitted from said GPS satellite;
transmitting from said portable telephone terminal present-location information on said present location and destination information indicating a destination specified by a customer of said taxi;
receiving by said communication controller said present-location information and destination information, and reading from said map-information storage unit, under the control of said controller, map information corresponding to said present-location information and destination information;
finding by said controller according to said read map information, a plurality of routes connecting said present location and destination;
receiving by said ITS information receiver ITS information provided by the ITS, and acquiring said ITS information by said controller;
calculating by said controller according to said acquired ITS information a required driving time for each of said plural routes;
determining by said controller an optimal route from said plural routes, which is a shortest-time route having a shortest required driving time;
calculating by said controller according to said map information a distance between said present location and destination associated with said shortest-time route;
reading from said preset-charge information storage unit under the control of said controller, service-charge information associated with a taxi company;
calculating by said controller according to said read service-charge information, a charge for said shortest-time route; and
generating by said controller information including shortest-time route information indicative of said shortest-time route, distance information indicative of said distance, and charge information indicative of said charge, and transmitting said information from said communication controller to said taxi by adding address information of said portable telephone terminal to said generated information.

60. A method of providing a transportation service according to claim 59, wherein said customer pays for a charge indicated by said charge information, before a transportation service associated with said destination is provided by said taxi.

61. A method of providing a transportation service according to claim 59, further comprising, if the customer changes the destination to a new destination when a service is being provided by said taxi, the steps of;
transmitting by said taxi from said portable telephone terminal to said center equipment present-location information at the time of said change and destination information indicating said new destination;
receiving by said center equipment using said communication controller, said new present-location information and said new destination information,
reading from said map-information storage unit by said controller, new map information corresponding to said new present-location information and new destination information;
finding by said controller according to said new map information, a plurality of new routes connecting said new present location and said new destination;
receiving by said ITS information receiver ITS information provided by the ITS, and acquiring said ITS information by said controller;
calculating by said controller according to said acquired ITS information a required driving time for each of said plural new routes;
determining by said controller an optimal route from said plural new routes, which is a new shortest-time route having the shortest required driving time;
calculating by said controller according to said new map information, a new distance between said new present location and new destination associated with said new shortest-time route;
calculating by said controller according to said service-charge information, a charge for said new shortest-time route; and
generating by said controller information including shortest-time route information indicative of said new shortest-time route, distance information indicative of said new distance, and charge information indicative of said new charge, and transmitting said information from said communication controller to said taxi by adding address information of said portable telephone terminal to said generated information.

62. A method of providing a transportation service according to claim 61, wherein said customer pays for a charge indicated by said new charge information, before a transportation service associated with said new destination is provided by said taxi.

63. A method of providing a transportation service in a system which comprises at least one Global Positioning System (GPS) satellite, a GPS terminal, a portable telephone terminal, a center equipment, and at least one taxi on which said GPS terminal and portable telephone terminal are mounted, said center equipment having a communication controller, a controller, a map-information storage unit, a preset-charge information storage unit, and an ITS information receiver, said method comprising the steps of:
detecting by said GPS terminal its present location according to information for finding a position of a moving object transmitted from said GPS satellite;
transmitting from said portable telephone terminal present-location information on said present location and destination information indicating a destination specified by a customer of said taxi;
receiving by said communication controller said present-location information and destination information, and reading from said map-information storage unit, under the control of said controller, map information corresponding to said present-location information and destination information;
finding by said controller according to said read map information, a plurality of routes connecting said present location and destination;
calculating by said controller according to said map information, a distance from said present location to said destination for each of said plural routes;
determining by said controller one of optimal routes which is a shortest route having the shortest distance among said plural routes;
receiving by said ITS information receiver ITS information provided by the ITS, and acquiring said ITS information by said controller;
calculating by said controller according to said acquired ITS information, a required driving time for each of said plural routes;
determining by said controller one of optimal routes which is a shortest-time route having a shortest required driving time among said plural routes;
reading from said preset-charge information storage unit under the control of said controller, service-charge information associated with a taxi company;
calculating by said controller according to said service-charge information, a charge for each of said plural routes;
determining by said controller one of optimal routes which is a lowest-charge route having a lowest charge among said plural routes; and
generating by said controller information including information indicating said shortest-distance route and its distance, information indicating said shortest-time route and its time, and information indicating said lowest-charge route and its charge, and transmitting said information to said taxi by adding address information of said portable telephone terminal to said generated information.

64. A method of providing a transportation service according to claim 63, further including a step of selecting by the customer one of said optimal routes before a transportation service associated with said destination is provided by said taxi, and paying a charge indicated by said charge information on said selected optimal route.

65. A method of providing a transportation service according to claim 64, further comprising, if the customer changes the destination to a new destination when a service is being provided by said taxi, the steps of;
transmitting by said taxi from said portable telephone terminal to said center equipment present-location information at the time of said change and destination information indicating said new destination;
receiving by said center equipment using said communication controller, said new present-location information and said new destination information,
reading from said map-information storage unit by said controller, new map information corresponding to said new present-location information and new destination information;
finding by said controller according to said new map information, a plurality of new routes connecting said new present location and said new destination;
calculating by said controller according to said new map information a distance from said new present location to said new destination for each of said optimal routes;
determining by said controller a new route as one of optimal routes which is a shortest route having the shortest distance among said plural routes;
acquiring by said controller new ITS information from said ITS information receiver;
calculating by said controller according to said acquired ITS information a required driving time for each of said plural routes;
determining by said controller a new route as one of optimal routes, which is a shortest-time route among said plural routes having the shortest required driving time;
calculating by said controller according to said service-charge information a charge for each of said plural routes;
determining by said controller a new route as one of optimal routes, which is a lowest-charge route among said plural routes having the lowest charge; and
generating by said controller information including new shortest-distance route information indicating said shortest-distance route, new shortest-time route information indicating said new shortest-time route, and new lowest-charge route information indicating said lowest-charge route, and transmitting said information to said taxi by adding address information of said portable telephone terminal to said generated information.

66. A method of providing a transportation service according to claim 65, further including a step of selecting by the customer one of said new optimal routes before a transportation service associated with said new destination is provided by said taxi, and paying a charge indicated by said charge information on said selected optimal route.

67. A method of providing a transportation service according to claim 62, wherein if the customer changes the destination to a new destination when a service is being provided by said taxi, said controller calculates a first charge for a route from said new present location to said destination according to said map information, to said ITS information, and to said service-charge information, calculates a second charge for a route from said new present location to said new destination according to said new map information, to said new ITS information, and to said service-charge information, subtracts said second charge from said first charge, and adds said second charge to said subtraction result to calculate said new charge.

68. A method of providing a transportation service according to claim 67, wherein said controller calculates a balance between said first charge and said new charge, and transmits to said taxi information on said balance together with information regarding said first charge via said communication controller.

69. A method of providing a transportation service according to claim 66, wherein, if the customer changes the destination to a new destination when a service is being provided by said taxi, said controller calculates a first charge for a route from said new present location to said destination according to said map information, to said ITS information, and to said service-charge information, calculates a second charge for a route from said new present location to said new destination according to said new map information, to said new ITS information, and to said service-charge information, subtracts said second charge from said first charge, and adds said second charge to said subtraction result to calculate said new charge.

70. A method of providing a transportation service according to claim 69, wherein said controller calculates a balance between said first charge and said new charge, and transmits to said taxi information on said balance together with information regarding said first charge via said communication controller.

71. A method of providing a transportation service according to claim 59, wherein said taxi receives by said portable telephone terminal information transmitted from said center equipment, reads from said map-information storage unit of said GPS terminal, under the control of a controller of said GPS terminal, map information corresponding to said optimal route included in said received information, displays on an image display said map information on which said optimal route is superposed, and displays a distance from said present location to said destination associated with said optimal route, a required driving time of said taxi associated with said optimal route, and a charge for said optimal route, included in said information sent from said center equipment.

72. A method of providing a transportation service according to claim 63, wherein said taxi receives by said portable telephone terminal information transmitted from said center equipment, reads from said map-information storage unit of said GPS terminal, under the control of a controller of said GPS terminal, map information corresponding to said optimal route included in said received information, displays on an image display said map information on which said optimal route is superposed, and displays a distance from said present location to said destination associated with said respective optimal routes, a required driving time of said taxi associated with said respective optimal routes, and charges for said respective optimal routes, included in said information sent from said center equipment.

73. A method of providing a transportation service according to claim 59, wherein, if the customer changes the destination to a new destination when a service is being provided by said taxi, said taxi receives by said portable telephone terminal new information sent from said center equipment, reads from said map-information storage unit of said GPS terminal, under the control of a controller of said GPS terminal, new map information corresponding to said new optimal route included in said new information received from said center equipment, displays on an image display said new map information on which said new optimal route is superposed, and displays a distance from said new present location to said new destination associated with said new optimal route, a required driving time of said taxi associated with said new optimal route, and a charge for said new optimal route, included in said new information.

74. A method of providing a transportation service according to claim 63, wherein, if the customer changes the destination to a new destination when a service is being provided by said taxi, said taxi receives by said portable telephone terminal new information sent from said center equipment, reads from said map-information storage unit of said GPS terminal, under the control of a controller of said GPS terminal, new map information corresponding to said respective new optimal routes included in said new information received from said center equipment, displays on an image display said new map information on which said respective new optimal routes is superposed, and displays a distance from said new present location to said new destination associated with said respective new optimal routes, a required driving time of said taxi associated with said respective new optimal routes, and charges for said respective new optimal routes, included in said new information.

75. A method of providing a transportation service according to claim 73, wherein said center equipment administers information obtained for said optimal route for every taxi.

76. A method of providing a transportation service according to claim 74, wherein said center equipment administers information obtained for said new optimal route for every taxi.

77. A method of providing a transportation service according to claim 73, wherein, for every taxi, said center equipment administers said information obtained with respect to said respective optimal routes, which has been obtained for an optimal route selected from among said optimal routes by the customer.

78. A method of providing a transportation service according to claim 74, wherein, for every taxi, said center equipment administers said information obtained with respect to said respective new optimal routes, which has been obtained for an optimal route selected from among said new optimal routes by the customer.

79. A method of providing a transportation service, comprising the steps of:
presenting to a customer by a taxi driver a charge for a transportation service corresponding to a destination specified by the customer when the customer gets in the taxi; and
paying for said charge by the customer before said transportation service is provided by the taxi.

80. A method of providing a transportation service according to claim 79, wherein said charge is calculated according to a present location where the customer gets in the taxi and to said destination.

81. A method of providing a transportation service according to claim 80, further comprising, if there is a change in the destination to a new destination during said transportation service is being provided by said taxi, the steps of;
calculating a new charge according to a present location at the time of said change and said new destination, said new charge being presented to the customer by the driver; and
paying by the customer said new charge before said transportation service associated with said new destination is provided by the taxi.

82. A method of providing a transportation service according to claim 81, wherein said charge is calculated for an optimal route between said present location and said destination.

83. A method of providing a transportation service, comprising the steps of:
finding respective optimal routes between a destination specified by a customer when the customer gets in the taxi and a present location at the time of said change, for respective different items;
calculating for said respective optimal routes charges for said transportation service provided by the taxi;
presenting to a customer by a taxi driver each of said charges calculated respectively for said optimal routes; and
selecting by the customer one of said optimal routes, and paying by the customer for a charge for said selected optimal route, before said transportation service is provided by the taxi.

84. A method of providing a transportation service according to claim 83, further comprising, if there is a change in the destination to a new destination during said transportation service is being provided by said taxi, the steps of;
finding new optimal routes between a new destination at the time of said change and said new destination, for said respective different items;
calculating new charges for said transportation service provided by the taxi, for each of said new optimal routes;
presenting to the customer by the taxi driver each of said new charges calculated for each of said new optimal routes; and
selecting by the customer one of said new optimal routes, and paying by the customer a charge for said selected optimal route, before said transportation service associated with said new destination is provided by the taxi.
